(19) United States
(12) Patent Application Publication
(10) Pub. No.: US 2012/0133668 A1
(43) Pub. Date: May 31, 2012

(54) Image display device, driving method of image display device, image display program, and gradation conversion device

(75) Inventors: Tsutomu Harada, Kanagawa (JP); Naoyuki Takasaki, Kanagawa (JP); Ryoichi Tsuzaki, Kanagawa (JP); Amane Higashi, Aichi-Ken (JP)

(73) Assignee: Sony Corporation, Tokyo (JP)

(21) Appl. No.: 13/317,367

(22) Filed: Oct. 17, 2011

(30) Foreign Application Priority Data
Nov. 29, 2010 (JP) 2010-264760

(51) Int. Cl. G09G 5/10; G09G 5/02; G09G 3/20

(52) U.S. Cl. 345/589; 345/55; 345/690

(57) ABSTRACT

There is provided an image display device including a display unit that displays an image by pixels that are arranged in a two-dimensional matrix pattern; and a gradation conversion unit that performs gradation conversion using a dither matrix of diffusion type, wherein the gradation conversion unit applies a dither matrix that is randomly shifted in a horizontal direction and a vertical direction and performs gradation conversion of an image that is displayed on a display unit to each region of pixels that corresponds to the dither matrix.

### BACKGROUND

The present disclosure relates to an image display device that displays an image on a display unit such as a liquid crystal display panel. Further, the disclosure relates to a driving method of the image display device, an image display program, and a gradation conversion device.

On the display unit of, for example, a mobile electronic apparatus such as a mobile phone or a mobile information terminal, a personal computer, or a television set, a liquid crystal display panel for monochrome display or color display, an electroluminescence display panel using electroluminescence of an inorganic material or an organic material, a plasma display panel, or the like is used.

In a case when the gradation display capability of the pixels of a display unit is low, in other words, in a case when there are few gradations of pixels, contours appear in the gradation portions of the image, and the image quality decreases. In such a case, the image quality is commonly improved by using methods such as an error diffusion method or an ordered dither method.

In the error diffusion method, an error that occurs when changing multivalued image data to, for example, binary image data (that is, the difference between the multivalued image data and the binary image data) has a weight coefficient added to a plurality of adjacent pixels and is “diffused” (R. W. Floyd and L. Steinberg, An adaptive algorithm for spatial greyscale, Journal of the Society for Information Display vol. 17, no. 2 pp 75-77, 1976). With the error diffusion method, it is possible to minimize an error that occurs between a multivalued original image and, for example, a binarized halftone image as an average, and it is possible to generate a halftone image with an excellent image quality.

The error diffusion method is a practical technique with a light calculation load. However, even in a case when a portion of the original image is changed, a change in error diffusion covers a wide range of the halftone image. Therefore, in a case when the error diffusion method is used to process a moving image, the screen may be noisy and unsightly.

On the other hand, the ordered dither method is a method that uses a matrix in which thresholds or noise are arranged (also referred to as a dither matrix, a mask, or the like). With the ordered dither method, the influence of a change of a portion of the original image does not cover a wide range of the halftone image. With the ordered dither method, although there is a method of threshold processing after adding each element of the dither matrix as noise to the original data and a method of varying the threshold based on each element of the dither matrix, the two methods are equivalent. For convenience of description, each element of the dither matrix is described to represent a threshold.

Basically, dither matrices are broadly divided into a concentration type and a diffusion type. As a concentration type dither matrix, a spiral type dither matrix and a dot type dither matrix are common. The concentration type dither matrix has a characteristic that thresholds are arranged so that a dot is thickened from the center and that the resolution is lowered if the pattern size is increased. Therefore, in the ordered dither method that uses a concentration type dither matrix, high resolution is not easily compatible with high gradation characteristics.

On the other hand, in a dispersion type dither matrix, thresholds are arranged so that dots are uniformly diffused, and a Bayer type matrix is a typical example (B. E. Bayer, An optimum method for two-level rendition of continuous-tone pictures, IEEE International Conference on Communications, vol. 1, Jun. 11-13, 1973, pp 11-15). With the diffusion type dither matrix, even if the pattern size is large, the resolution does not decrease. Therefore, with the ordered dither method that uses a diffusion type dither matrix, high resolution is able to be compatible with high gradation characteristics.

Similarly to the error diffusion method, the ordered dither method is a practical method with a light calculation load. With the ordered dither method, the influence of a change of a portion of the original image does not cover a wide range of the halftone image. Therefore, in a case when the ordered dither method is used to process a moving image, a phenomenon in which the screen becomes noisy does not occur.

### SUMMARY

The ordered dither method using the diffusion type dither matrix is able to make high resolution be compatible with high gradation characteristics, and is suitable for processing not only still images but also for processing moving images. However, for example, if an input image of a uniform gray level is gradation processed, a regular output pattern according to the arrangement of the dither matrix is generated. Therefore, there is a case in which grain-like pattern noise of a fixed cycle is perceived on an image after gradation processing, which is unsightly.

It is desirable to provide an image display device in which high resolution is compatible with high gradation characteristics and which is able to reduce grain-like pattern noise, a driving method of the image display device, an image display program, and a gradation conversion device.

An image display device according to an embodiment of the disclosure includes: a display unit that displays an image by pixels that are arranged in a two-dimensional matrix pattern; and a gradation conversion unit that performs gradation conversion using a diffusion type dither matrix, wherein the gradation conversion unit applies a dither matrix that is randomly shifted in the horizontal direction and the vertical direction and performs gradation conversion of an image that is displayed on the display unit to each region of pixels that corresponds to the dither matrix.

Further, a driving method of an image display device according to another embodiment of the disclosure uses an image display device including a display unit that displays an image by pixels that are arranged in a two-dimensional matrix pattern and a gradation conversion unit that performs gradation conversion using a diffusion type dither matrix. The method includes applying a dither matrix that is randomly shifted in a horizontal direction and a vertical direction to each region of pixels that corresponds to a dither matrix and performing gradation conversion of an image that is displayed on a display unit by the gradation conversion unit.

Furthermore, an image display program according to still another embodiment of the disclosure causes a process of randomly shifting and applying a dither matrix in the horizontal direction and the vertical direction to each region of pixels that corresponds to the dither matrix to be performed by being executed in an image display device that includes a display unit that displays an image by pixels that are arranged in a two-dimensional matrix pattern and a gradation conversion unit for performing a gradation conversion using a diffusion type dither matrix.

Furthermore, a gradation conversion device according to still another embodiment of the disclosure includes a gradation conversion unit that performs gradation conversion using a diffusion type dither matrix, wherein the gradation conversion unit applies a dither matrix that is randomly shifted in the horizontal direction and the vertical direction and performs gradation conversion of an image to each region of pixels that corresponds to the dither matrix.

According to the image display device according to the embodiment of the disclosure, since a dither matrix is randomly shifted in the horizontal direction and the vertical direction and applied to each region of pixels that corresponds to the dither matrix, it is possible to display an image in which the grain-like pattern noise that is characteristic of the dither matrix is greatly reduced. Further, by using the driving method of the image display device, the image display program, and the gradation conversion device according to the embodiments of the disclosure, it is possible to greatly reduce the grain-like pattern noise that is characteristic of a dither matrix.

### BRIEF DESCRIPTION OF THE DRAWINGS

FIG. 1 is a conceptual diagram of an image display device according to a First Embodiment;

FIG. 2 is a schematic plan diagram for describing the relationship between a pixel that is positioned at column x, row y and input data in a display region, and a region of pixels that corresponds to a dither matrix;

FIG. 3 is a schematic plan diagram for describing the arrangement of a region of pixels that corresponds to a dither matrix;

FIG. 4A is a schematic plan diagram for describing the relationship between a pixel that is positioned at column x, row y in a display region and a pixel that is positioned at column i, row j, in the region TE (p, q). FIG. 4B is a schematic plan diagram for describing the relationship between a pixel that is positioned at column i, row j in the region TE (p, q) and an element of a dither matrix;

FIG. 5A is a table that illustrates the thresholds when the value of the input data is equal to or greater than 86 and equal to or less than 170. FIG. 5B is a table that illustrates the thresholds when the value of the input data is equal to or greater than 171 and equal to or less than 255;

FIG. 6 is a schematic flowchart for describing the actions of dither processing of the related art;

FIG. 7A is a schematic diagram for describing input data that corresponds to each pixel in the region TE (p, q). FIG. 7B is a schematic diagram for describing output data that corresponds to each pixel in the region TE (p, q);

FIG. 8 is a schematic plan diagram for describing the shift amounts of a dither matrix in the region TE (p, q);

FIG. 9 is a schematic plan diagram for describing a chain of dither matrices;

FIG. 10A is a schematic plan diagram for describing the shift amount of a dither matrix in the horizontal direction. FIG. 10B is a schematic plan diagram for describing the shift amount of a dither matrix in the vertical direction;

FIG. 11 is a table in which the values of the shift amounts of a dither matrix in the horizontal direction and the vertical direction in the region TE (p, q) are shown;

FIG. 12A is a schematic plan diagram for describing the value of input data that corresponds to a pixel that is positioned at column i, row j in the region TE (p, q). FIG. 12B is a schematic plan diagram for describing the value of a threshold that corresponds to a pixel that is positioned at column i, row j in the region TE (p, q);

FIG. 13 is a schematic flowchart for describing the actions of the gradation conversion unit of the image display device according to the First Embodiment;

FIGS. 14A and 14B are tables for comparing output data from when dither processing of the related art is performed and output data from when the actions of the First Embodiment are performed on input data that corresponds to the pixels in the region TE (p, q);

FIG. 15 is a conceptual diagram of an image display device according to a Second Embodiment;

FIG. 16 is a schematic plan diagram for describing the relationship between a pixel that is positioned at column x, row y and input data in a display region, and a region of pixels that corresponds to a dither matrix;

FIG. 17A is a schematic plan diagram for describing the relationship between the three subpixels that configure a pixel that is positioned at column x, row y in a display region and the three subpixels that configure a pixel that is positioned at column i, row j in the region TE (p, q). FIG. 17B is a schematic plan diagram for describing the relationship between the three subpixels that configure a pixel that is positioned at column i, row j in the region TE (p, q) and input data that corresponds to each subpixel;

FIG. 18 is a schematic flowchart for describing the actions of the gradation conversion unit of the image display device according to the Second Embodiment;

FIG. 19 is a conceptual diagram of an image display device according to a Third Embodiment;

FIG. 20A is a table in which the values of the shift amounts of a dither matrix that corresponds to a first subpixel in the region TE (p, q) in the horizontal direction and the vertical direction are shown. FIG. 20B is a table in which the values of the shift amounts of a dither matrix that corresponds to a second subpixel in the region TE (p, q) in the horizontal direction and the vertical direction are shown. FIG. 20C is a table in which the values of the shift amounts of a dither matrix that corresponds to a third subpixel in the region TE (p, q) in the horizontal direction and the vertical direction are shown.

FIG. 21 is a schematic flowchart for describing the actions of a gradation conversion unit of the image display device according to the Third Embodiment;

FIG. 22 is a conceptual diagram of an image display device according to a Fourth Embodiment;

FIG. 23 is a schematic plan diagram for describing the shift amounts of a dither matrix that is applied to the first subpixel and the third subpixel in the region TE (p, q) and the shift amounts of a dither matrix that is applied to the second subpixel;

FIG. 24 is a schematic flowchart for describing the actions of the first subpixel and the third subpixel of the image display device according to the Fourth Embodiment;

FIG. 25 is a schematic flowchart for describing the actions of the second subpixel of the image display device according to the Fourth Embodiment;

FIG. 26 is a conceptual diagram of an image display device according to a Fifth Embodiment;

FIG. 27A is a table in which the values of matrix deformation parameters in the region TE (p, q) are shown.

FIG. 27B is a table in which the correspondence relationship between matrix deformation parameters and the content of the deformation is shown;

FIGS. 28A to 28D are diagrams on which a dither matrix is shown when the matrix conversion parameter is respectively 0 to 3;

FIGS. 29A to 29D are diagrams on which a dither matrix is shown when the matrix conversion parameter is respectively 4 to 7; and

FIG. 30 is a schematic flowchart for describing the actions of a gradation conversion unit of an image display device according to the Fifth Embodiment.

### DETAILED DESCRIPTION OF EMBODIMENTS

The disclosure will be described below based on embodiments with reference to the drawings. The disclosure is not limited to the embodiments, and the various numerical values and materials in the embodiments are only examples. In the description below, the same symbols are used for the same elements or elements with the same functions, and duplicate descriptions are omitted. Here, description will be performed in the following order.

1. General Description of Image Display Device, Driving Method of Image Display Device, Image Display Program, and Gradation Conversion Device

2. First Embodiment

3. Second Embodiment

4. Third Embodiment

5. Fourth Embodiment

6. Fifth Embodiment (Others)

### [General Description of Image Display Device, Driving Method of Image Display Device, Image Display Program, and Gradation Conversion Device]

In an image display device according to an embodiment of the disclosure, an image display device that is used for a driving method of an image display device according to an embodiment of the disclosure, or an image display device in which an image display program according to an embodiment of the disclosure is executed (hereinbelow, also referred to simply as an image display device according to an embodiment of the disclosure), the configuration or the method of a display unit that displays an image is not particularly limited. The display unit may be one that is suited to the display of moving images or one that is suited to the display of still images. For example, a common display device such as a liquid crystal display panel, an electroluminescence display panel, or the plasma display panel may be used as the display unit, or a display medium such as electrically rewritable electronic paper may be used as the display unit. Moreover, a printing apparatus such as a printer may be used as the display unit. The display unit may be a monochrome display or a color display.

A gradation conversion unit that performs gradation conversion using a diffusion type dither matrix or a gradation conversion device that includes a gradation conversion unit is able to be configured, for example, by an operation circuit or a storage device. The operation circuit or the storage device is able to be configured using common circuit elements and the like.

The gradation conversion unit applies a dither matrix that is randomly shifted in the horizontal direction and the vertical direction to each region of pixels that corresponds to the dither matrix, and performs gradation conversion of an image that is displayed on a display unit. Here, “randomly shifting in the horizontal direction and the vertical direction” may also include a case when randomly shifting in either the horizontal direction or the vertical direction. Further, “randomly shifting in the horizontal direction and the vertical direction” may also include a case when the shift in the horizontal direction and the vertical direction is 0.

The size or the configuration of the diffusion type dither matrix is not particularly limited, and may be appropriately selected according to the design of the image display device or the like. As the diffusion type dither matrix, a Bayer type matrix is able to be exemplified.

The gradation conversion by the gradation conversion unit may be a process of converting a multivalued image into a binary image such as, for example, converting 256 gradations to 2 gradations. Alternatively, the gradation conversion may be a process of converting a multivalued image into a multivalued image with fewer gradations such as, for example converting 256 gradations to 4 gradations.

In an image display device according to an embodiment of the disclosure, a configuration in which a dither matrix is composed of a Bayer type matrix and the gradation conversion unit applies a dither matrix that is randomly shifted in the horizontal direction and the vertical direction by an even number of pixels is possible.

In the frequency components of the Bayer type matrix, the wavelength of a high-frequency component is 2 pixels. Therefore, with such a configuration, even when a dither matrix that is shifted is applied, a phenomenon such as the widths of light portions or dark portions widening due to phase shifting of the high-frequency component does not occur. Here, the configuration may include a case when there is a shift by 0 pixels (that is, the shift amount is 0). That is, “shifting by an even number of pixels” may also include a case when there is a shift by 0 pixels.

In an image display device according to an embodiment of the disclosure which includes the various preferable configurations described above, a pixel may be configured as a single pixel. Alternatively, a pixel may be configured by a plurality of types of subpixels. In the case of the latter, a configuration in which the gradation conversion unit applies a dither matrix for every type of subpixel that configures the region of pixels that corresponds to a dither matrix is possible.

As the values of a pixel, although several image display resolutions such as (1920, 1035), (720, 480), and (1280, 960) are able to be exemplified as well as VGA (640, 480), S-VGA (800, 600), XGA (1024, 768), APRC (1152, 900), S-XGA (1280, 1024), U-XGA (1600, 1200), HD-TV (1920, 1080), and Q-XGA (2048, 1536), the values of a pixel are not limited to such values.

In an image display device according to an embodiment of the disclosure which includes the preferable configurations described above and in which a pixel is configured by a plurality of subpixels, a configuration in which a pixel includes at least three types of subpixels and the gradation conversion unit applies a dither matrix that is shifted by the same conditions for at least two types of subpixels and applies a dither matrix that is shifted by different conditions for other types of subpixels in a region of pixels that corresponds to the dither matrix is possible. For example, in a case when three types of subpixels are included, a configuration in which a dither matrix that is shifted by the same conditions is applied for two types of subpixels and a dither matrix that is shifted by different conditions is applied for the other type of subpixel is possible. Further, for example, in a case when four types of subpixels are included, a configuration in which a dither matrix that is shifted by the same conditions is applied for two types of subpixels and a dither matrix that is shifted by different conditions is applied for the other two types of subpixels is possible. Alternatively, a configuration in which a dither matrix that is shifted by the same conditions is applied for three types of subpixels and a dither matrix that is shifted by different conditions is applied for the other type of subpixel is also possible.

In such a case, in the region of pixels that corresponds to a dither matrix, a configuration in which the gradation conversion unit applies a dither matrix that is shifted by the same conditions for two types of subpixels and applies a dither matrix that is shifted by the same conditions which are further shifted by a fixed amount in both the horizontal direction and the vertical direction for other types of subpixels is possible. Further, a configuration in which the other types of subpixels are of a color that contributes the most to brightness is possible.

In an image display device according to an embodiment of the disclosure which includes the various preferable configurations described above, a configuration in which the gradation conversion unit applies a dither matrix that is shifted by the same amount in a region of pixels that corresponds to the dither matrix for each display frame is possible. The same is also the case of a gradation conversion device according to an embodiment of the disclosure.

By such a configuration, gradation conversion is performed in each display frame by the same conditions. Therefore, when an observer views a moving image, a problem in which noise is observed in the moving image due to the difference in the shift amounts of the dither matrices does not arise.

In an image display device according to an embodiment of the disclosure which includes the various preferable configurations described above, a configuration in which the gradation conversion unit selects and applies either one of a matrix in which a dither matrix is rotated or a matrix in which a dither matrix is inverted in the horizontal direction, the vertical direction, or a diagonal direction as the dither matrix to each region of pixels that corresponds to the dither matrix is possible.

Here, a configuration in which the rotation angle of the dither matrix includes 0 degrees as well as 90 degrees, 180 degrees, and 270 degrees is possible. That is, “matrix in which a dither matrix is rotated” may also include a matrix with a rotation angle of 0 degrees.

An image display program according to an embodiment of the disclosure causes a process in which a dither matrix that is randomly shifted in the horizontal direction and the vertical direction is applied to each region of pixels that corresponds to the dither matrix to be performed by being executed on an image display device that includes a display unit that displays an image by pixels that are arranged in a two-dimensional matrix pattern and a gradation conversion unit for performing gradation conversion using a diffusion type dither matrix.

A configuration in which such an image display program is stored in a storage section such as a semiconductor memory, a magnetic disk, or an optical disc and the process described above is executed in the gradation conversion unit is possible.

A configuration in which an image display device according to an embodiment of the disclosure includes a storage section in which a dither matrix that is the basis is stored and a storage section in which random shifting conditions are stored is also possible. Alternatively, a configuration of including a storage section in which a dither matrix that is the basis is stored and a random number generation section that determines the random shifting conditions is possible. Further, various configurations such as a configuration of including a storage section in which many shifted dither matrices are stored and a selection circuit of the dither matrices or a configuration of including a storage section that stores a matrix that corresponds to the entire display unit as an aggregate of randomly shifted dither matrices which is generated in advance may be adopted. The choice of configuration may be determined appropriately according to the design or the form of the image display device.

### First Embodiment

The First Embodiment relates to an image display device, a driving method of the image display device, an image display program, and a gradation conversion device according to an embodiment of the disclosure.

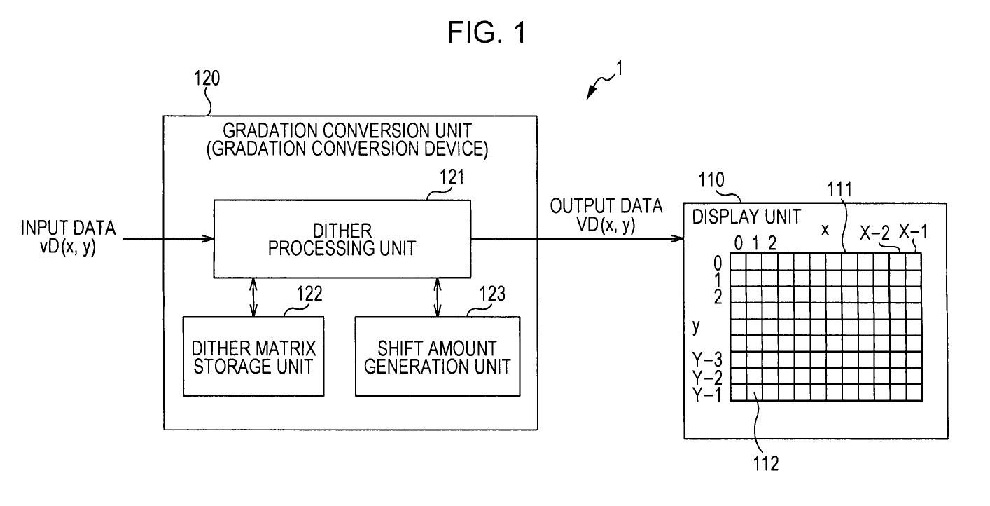

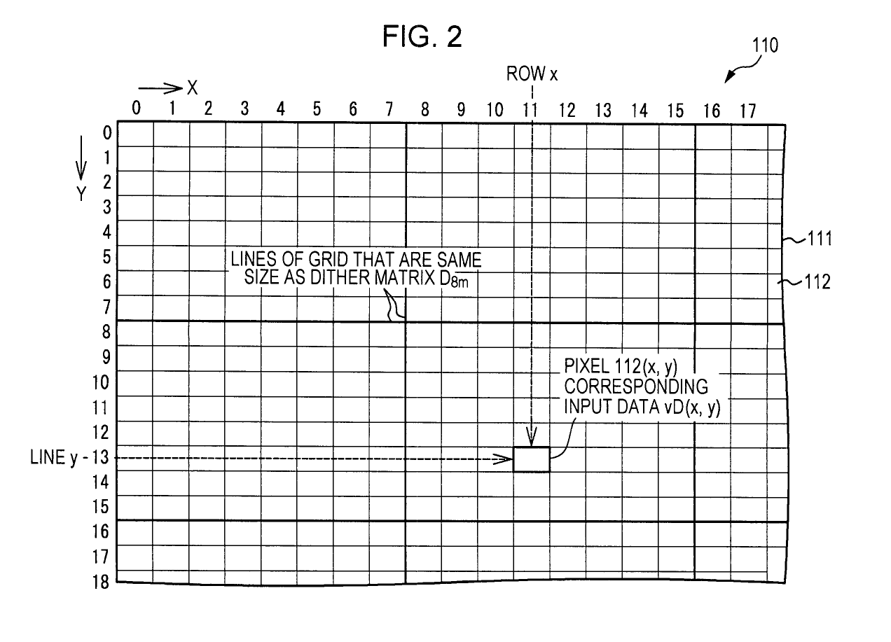

FIG. 1 is a conceptual diagram of an image display device according to the First Embodiment. FIG. 2 is a schematic plan diagram for describing the relationship between a pixel that is positioned at column x, row y and input data in a display region, and a region of pixels that corresponds to a dither matrix.

An image display device 1 of the First Embodiment includes a display unit 110 that displays an image by pixels 112 that are arranged in a two-dimensional matrix pattern and a gradation conversion unit (gradation conversion device) 120 that performs gradation conversion using a diffusion type dither matrix. The gradation conversion unit 120 applies a dither matrix that is randomly shifted in the horizontal direction and the vertical direction to each region of the pixels 112 that corresponds to the dither matrix, and performs gradation conversion of the image of the display unit 110 by generating gradation converted output data VD.

The display unit 110 is configured by a liquid crystal display panel of a monochrome display. A total of X×Y pixels 112 in which there are X pixels in the horizontal direction (hereinafter, also referred to as the row direction) and Y pixels in the vertical direction (hereinafter, also referred to as the column direction) are arranged in a two-dimensional matrix pattern in a display region 111 of the display unit 110. In the case of a transmission type display panel, by controlling the light transmissivity of the pixels 112 based on the values of the output data VD, the transmission amount of light from a light source device (not shown) is controlled and an image is displayed on the display unit 110. In the case of a reflection type display panel, by controlling the light transmissivity of the pixels 112 based on the values of the output data VD, the reflection amount of external light is controlled and an image is displayed on the display unit 110.

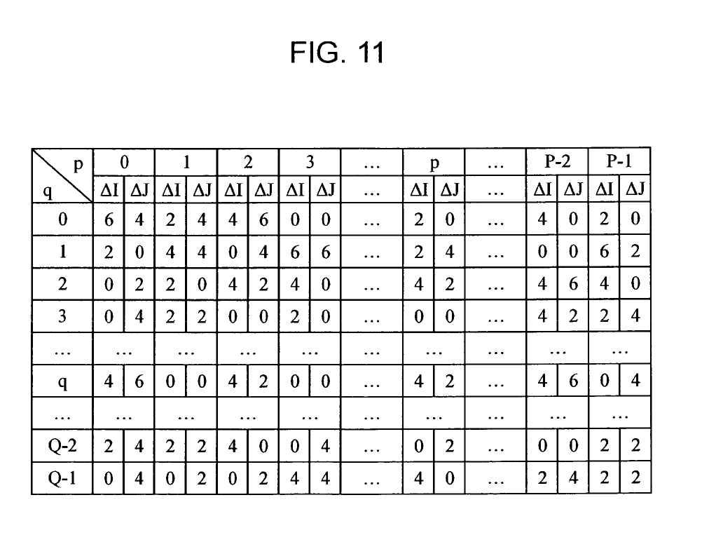

The gradation conversion unit 120 includes a dither processing unit 121, a dither matrix storage unit 122, and a shift amount generation unit 123. A Bayer type dither matrix D₈ₘ of a diffusion type described later is stored in the dither matrix storage unit 122, and the parameters illustrated in FIG. 11 described later are stored as a table in the shift amount generation unit 123.

Input data vD corresponding to each of the pixels 112 is input to the gradation conversion unit 120. By the dither processing unit 121, gradation conversion is performed based on the values of the dither matrix storage unit 122, the values of the shift amount generation unit 123, or the like and the output data VD is output.

A pixel 112 that is positioned at column x (where x=0, 1 . . . , X−1) and row y (where y=0, 1 . . . , Y−1) is represented as the (x, y) pixel 112 or the pixel 112 (x, y). The input data vD and the output data VD that correspond to the pixel 112 (x, y) are respectively represented as input data vD (x, y) and output data VD (x, y).

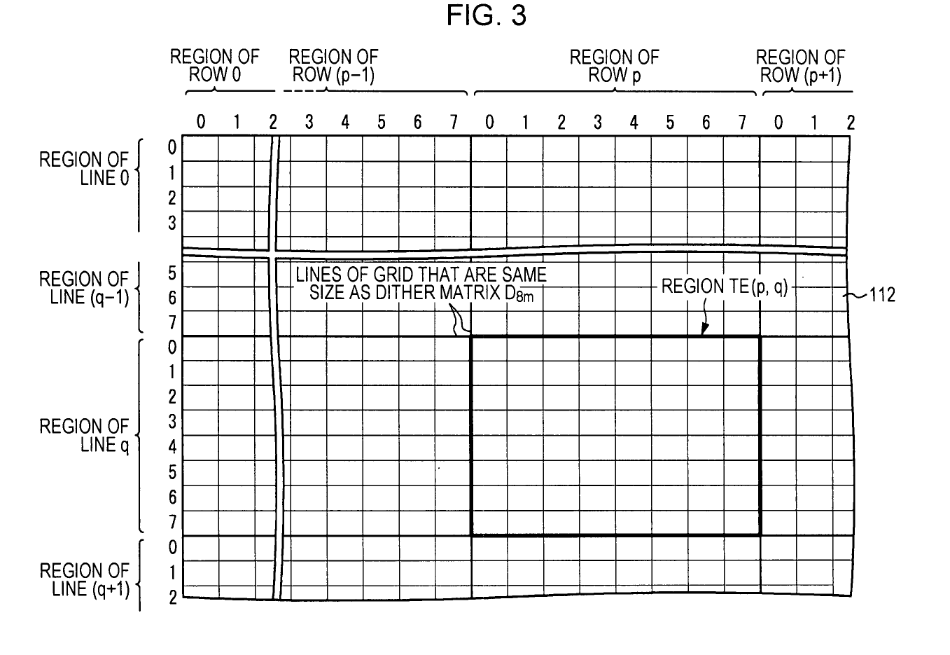

FIG. 3 is a schematic plan diagram for describing the arrangement of a region of pixels that corresponds to a dither matrix.

The display region 111 is hypothetically divided by the lines of a grid to each region of a portion that is the same size as the dither matrix D₈ₘ. Specifically, the display region 111 is divided into a region TE with a total of P×Q regions in which there are P regions in the row direction and Q regions in the column direction. As described later, since the dither matrix D₈ₘ, is a square matrix of 8×8, if there is no remainder, 2=X/8 and Q=Y/8. The region TE that is positioned at column p (where p=0, 1 . . . , P−1) and row q (where q=0, 1 . . . , Q−1) is expressed as the (p, q) region TE or the region TE (p, q).

The relationship between the symbols “x, y, p, q, i, j” when the row numbers and the column numbers of the pixels 112 that configure the region TE (p, q) are expressed as column i (where i=0, 1 . . . , 7) and row j (where j=0, 1 . . . , 7) in the region TE (p, q) will be described.

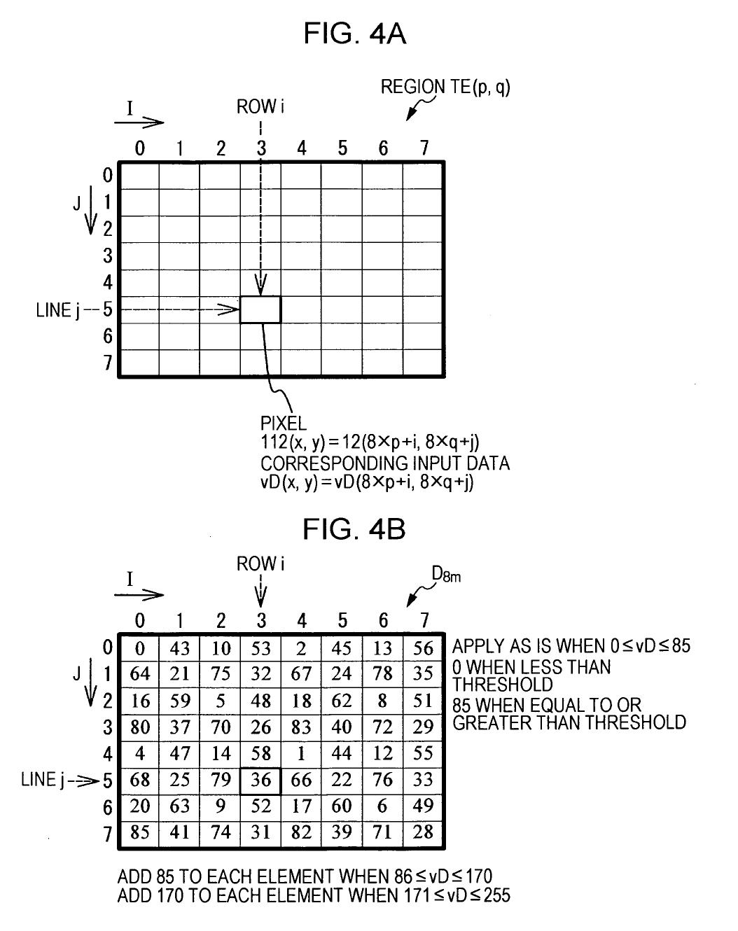

FIG. 4A is a schematic plan diagram for describing the relationship between a pixel that is positioned at column x, row y in a display region and a pixel that is positioned at column i, row j, in the region TE (p, q). FIG. 4B is a schematic plan diagram for describing the relationship between a pixel that is positioned at column i, row j in the region TE (p, q) and an element of a dither matrix.

If the pixel 112 (x, y) that is positioned at column x, row y in the display region 111 is to be positioned at column i, row j in the region TE (p, q), the relationships of x=8×p+i and y=8×q+j hold true.

As is seen from the above equations, the symbol i is the remainder when the symbol x is divided by 8, and the symbol j is the remainder in a case when the symbol y is divided by 8. Further, the symbol p is the integer portion of the quotient when the symbol x is divided by 8, and the symbol q is the integer portion of the quotient when the symbol y is divided by 8.

In other words, if the number in which the symbol x is expressed in binary form is represented by (x)₂ and the number in which the symbol y is expressed in binary form is represented by (y)₂, the symbols “i, j” are respectively expressed by numbers from the 3 lower order bits of (x)₂ and (y)₂. Further, the symbols “p, q” are respectively expressed by numbers from the higher order bits to the 4th lower order bit of (x)₂ and (y)₂.

Next, the dither matrix D₈ₘ that is stored in the dither matrix storage unit 122 will be described.

The dither matrix D₈ₘ is composed of a so-called Bayer type dither matrix, and is a square matrix of 8×8.

A Bayer type dither matrix is basically able to be generated by Equation 1 below.

$$\begin{matrix}{D}_{N} = [ \begin{matrix}4 {D}_{N / 2} & 4 {D}_{N / 2} + 2 {U}_{N / 2} \\ 4 {D}_{N / 2} + 3 {U}_{N / 2} & 4 {D}_{N / 2} + {U}_{N / 2}\end{matrix} ] \\ where & ( 1 ) \\ {D}_{1} = [ 0 ] & ( 2 ) \\ {U}_{N} = [ \begin{matrix}1 & … & 1 \\ ⋮ & ⋱ & ⋮ \\ 1 & … & 1\end{matrix} ] & ( 3 )\end{matrix}$$

Therefore, dither matrices D₂, D₄, and D₈ are respectively able to be expressed by Equation 4, Equation 5, and Equation 6 below.

$$\begin{matrix}{D}_{2} = [ \begin{matrix}0 & 2 \\ 3 & 1\end{matrix} ] & ( 4 ) \\ {D}_{4} = [ \begin{matrix}0 & 8 & 2 & 10 \\ 12 & 4 & 14 & 6 \\ 3 & 11 & 1 & 9 \\ 15 & 7 & 13 & 5\end{matrix} ] & ( 5 ) \\ {D}_{8} = [ \begin{matrix}0 & 32 & 8 & 40 & 2 & 34 & 10 & 42 \\ 48 & 16 & 56 & 24 & 50 & 18 & 58 & 26 \\ 12 & 44 & 4 & 36 & 14 & 46 & 6 & 38 \\ 60 & 28 & 52 & 20 & 62 & 30 & 54 & 22 \\ 3 & 35 & 11 & 43 & 1 & 33 & 9 & 41 \\ 51 & 19 & 59 & 27 & 49 & 17 & 57 & 25 \\ 15 & 47 & 7 & 39 & 13 & 45 & 5 & 37 \\ 63 & 31 & 55 & 23 & 61 & 29 & 53 & 21\end{matrix} ] & ( 6 )\end{matrix}$$

In the First Embodiment, 256 gradations are converted to 4 gradations. In other words, an 8 bit image is gradation converted to a 2 bit image. So-called multivalued dither is executed by dividing the range of input gradations into a plurality of ranges and performing binary dither within the respective ranges. If the four values of 2 bits are 0, 85, 170, and 255 gradations, the input gradations are divided into the three ranges of 0 to 85, 86 to 170, and 171 to 255.

In such a case, dither processing is performed on gradation widths that are generally 85 for each of the ranges. Therefore, the dither matrix D₈ₘ below is obtained by multiplying each element of the dither matrix D₈ by a constant and making each element into an integer so that the maximum value of the elements becomes 85.

$${D}_{8 m} = [ \begin{matrix}0 & 43 & 10 & 53 & 2 & 45 & 13 & 56 \\ 64 & 21 & 75 & 32 & 67 & 24 & 78 & 35 \\ 16 & 59 & 5 & 48 & 18 & 62 & 8 & 51 \\ 80 & 37 & 70 & 26 & 83 & 40 & 72 & 29 \\ 4 & 47 & 14 & 58 & 1 & 44 & 12 & 55 \\ 68 & 25 & 79 & 36 & 66 & 22 & 76 & 33 \\ 20 & 63 & 9 & 52 & 17 & 60 & 6 & 49 \\ 85 & 41 & 74 & 31 & 82 & 39 & 71 & 28\end{matrix} ] \qquad ( 7 )$$

Details of the dither processing will be described below. In order to aid understanding, first, the driving method of the related art in which the dither matrix D₈ₘ is applied as is to each region TE will be described.

Here, in the description below, each element of the dither matrix D₈ₘ will be described as thresholds.

As is seen from FIGS. 4A and 4B, in a case when the dither matrix D₈ₘ is applied as is to each region TE, the element of the dither matrix D₈ₘ at column i, row j (hereinafter, also expressed as D₈ₘ (i, j)) corresponds to the pixel 112 positioned at column i, row j in the region TE (p, q). For example, in a case when i=3 and j=5, D₈ₘ (3, 5) in the third column and the fifth row of the dither matrix D₈ₘ corresponds to the pixel 112.

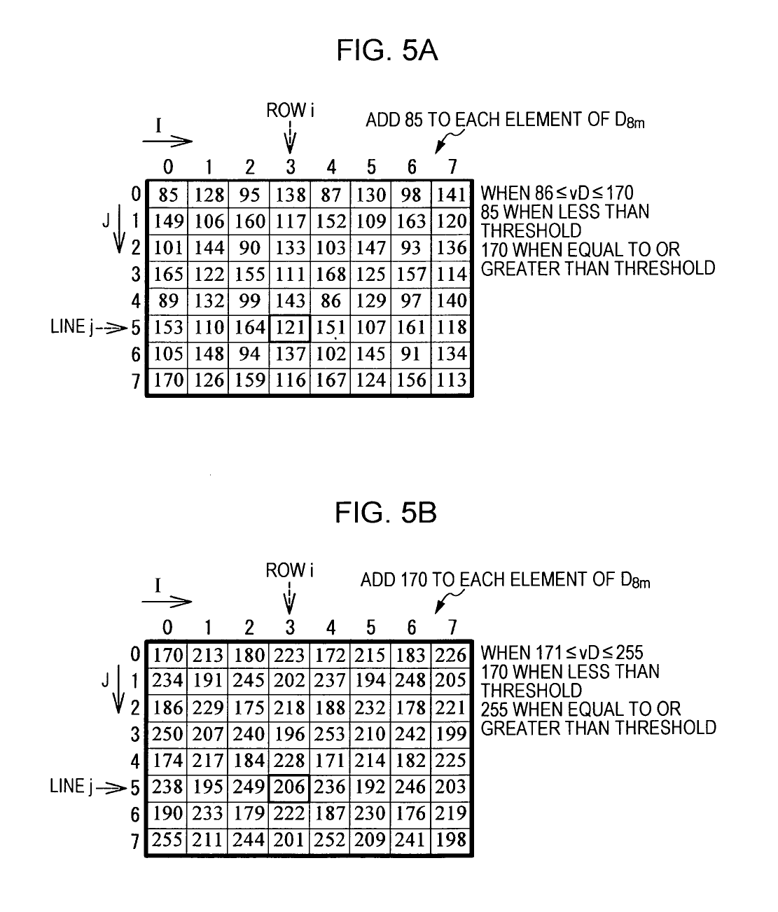

Further, in a case when the value of the input data vD that corresponds to the pixel 112 that is positioned at column i, row j in the region TE (p, q) is equal to or greater than 0 and equal to or less than 85, the value of D₈ₘ (i, j) becomes the threshold as is. Furthermore, in a case when the value of the input data vD is equal to or greater than 86 and equal to or less than 170, a value in which 85 is added to the value of D₈ₘ (i, j) becomes the threshold. In a case when the value of the input data vD is equal to or greater than 171 and equal to or less than 255, a value in which 170 is added to the value of D₈ₘ (i, j) becomes the threshold. The threshold when the value of input data is equal to or greater than 86 and equal to or less than 170 is illustrated in FIG. 5A. The threshold when the value of input data is equal to or greater than 171 and equal to or less than 255 is illustrated in FIG. 5B.

Here, a configuration in which the value of the input data vD is left as is in a case when the value of the input data vD is equal to or greater than 0 and equal to or less than 85, 85 is subtracted from the input data vD in a case when the value of the input data vD is equal to or greater than 86 and equal to or less than 170, and 170 is subtracted from the input data vD in a case when the value of the input data vD is equal to or greater than 171 and equal to or less than 255 and the value of D₈ₘ (i, j) is left as is as the threshold is possible.

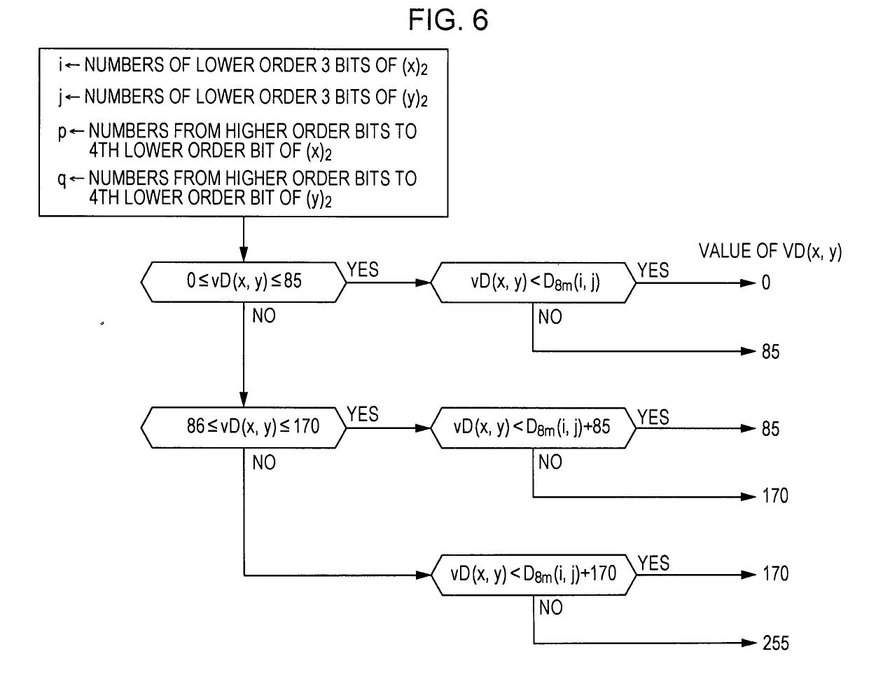

FIG. 6 is a schematic flowchart for describing the actions of dither processing of the related art.

As described above, if the pixel 112 (x, y) that is positioned at column x and row y in the display region 111 is to be positioned at column i and row j in the region TE (p, q), the relationship of x=8×p+i and y=8×q+j holds true. The symbols “i, j” are respectively expressed by numbers from the 3 lower order bits of (x)₂ and (y)₂. The symbols “p, q” are respectively expressed by numbers from the higher order bits to the 4th lower order bit of (x)₂ and (y)₂.

In a case when the value of the input data vD (x, y) that corresponds to the pixel 112 (x, y) that is positioned at column x, row y in the display region 111 is equal to or greater than 0 and equal to or less than 85, if the input data vD (x, y)<D₈ₘ (i, j), the value of the output data VD (x, y) becomes 0. In a case when the conditions described above are not established, in other words, if the input data vD (x, y)≧D₈ₘ, (i, j), the value of the output data VD (x, y) becomes 85.

Further, in a case when the value of the input data vD (x, y) is equal to or greater than 86 and equal to or less than 170, if the input data vD (x, y)<[D₈ₘ (i, j)+85], the value of the output data VD (x, y) becomes 85. In a case when the conditions described above are not established, in other words, if the input data vD (x, y)[D₈ₘ (i, j)+85], the value of the output data VD becomes 170.

Furthermore, in a case when the value of the input data vD (x, y) is equal to or greater than 171 and equal to or less than 255, if the input data vD (x, y)<[D₈ₘ (i, j)+170], the value of the output data VD becomes 170. In a case when the conditions described above are not established, in other words, if the input data vD (x, y)≧[D₈ₘ (i, j)+170], the value of the output data VD becomes 255.

By performing sequential determination for the input data vD (0, 0) to vD (X−1, Y−1) according to the flowchart illustrated in FIG. 6, the output data VD (0, 0) to VD (X−1, Y−1) is able to be obtained.

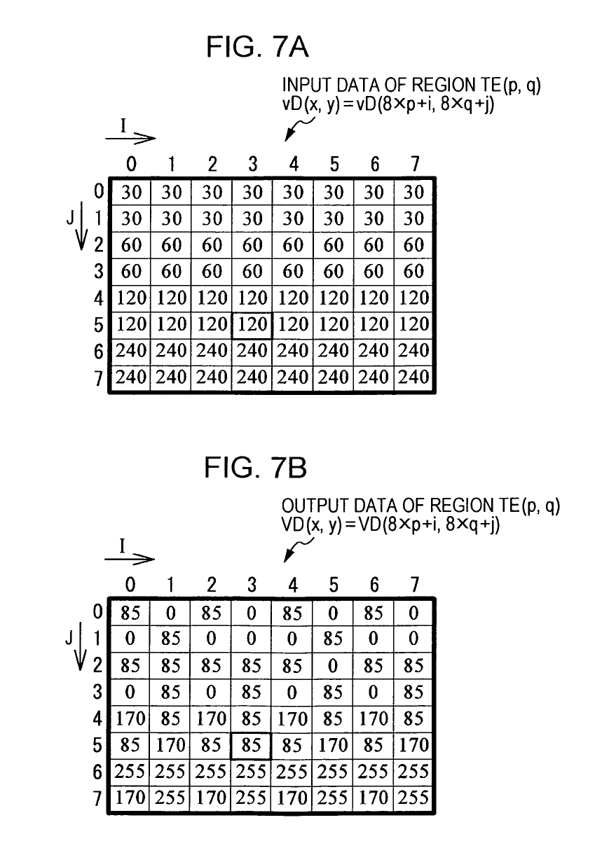

FIG. 7A is a schematic diagram for describing input data that corresponds to each pixel in the region TE (p, q). FIG. 7B is a schematic diagram for describing output data that corresponds to each pixel in the region TE (p, q).

In the example illustrated in FIG. 7A, the value of the input data vD that corresponds to the pixels 112 on row 0 and row 1 in the region TE (p, q) is “30” and the value of the input data vD that corresponds to the pixels 112 on row 2 and row 3 is “60”. Further, the value of the input data vD that corresponds to the pixels 112 on row 4 and row 5 is “120” and the value of the input data vD that corresponds to the pixels 112 on row 6 and row 7 is “240”.

For example, with the pixel 112 that is positioned on column 3 and row 5 in the region TE (p, q), the value of the input data vD that corresponds to the pixel 112 is “120”, and vD is equal to or greater than 86 and equal to or less than 170. Therefore, the value “121” in which 85 is added to the value of D₈ₘ (3, 5) becomes the threshold. Further, since vD=120<121 and vD is a value that is less than the threshold, the value of the output data VD becomes “85”.

Hitherto, the driving method of the related art has been described. Next, the driving method of the image display device 1 according to the First Embodiment will be described.

The gradation conversion unit 120 applies a dither matrix D₈ₘ that is randomly shifted in the horizontal direction and the vertical direction to each region of the pixels 112 that corresponds to the dither matrix D₈ₘ.

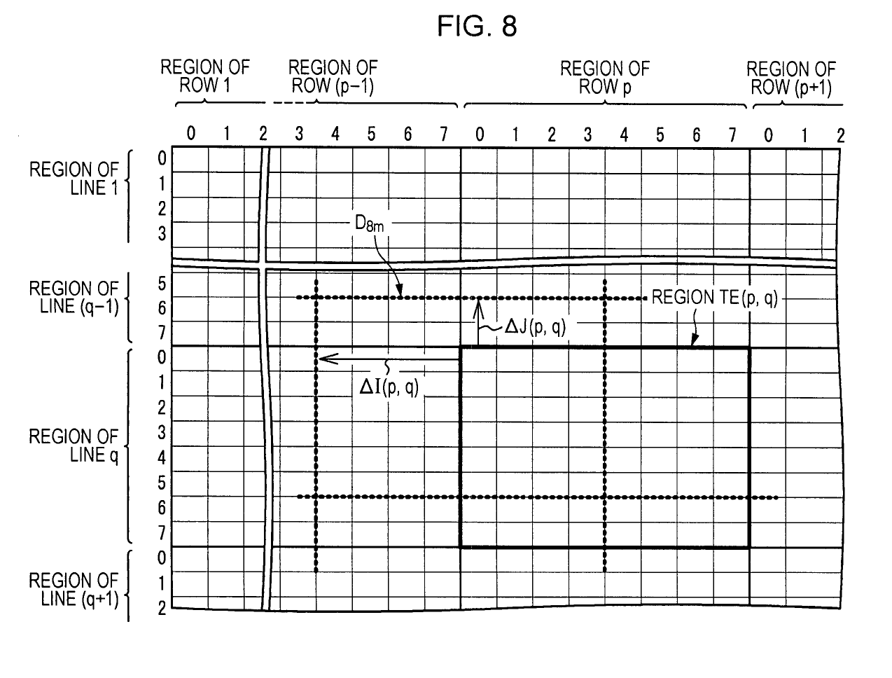

FIG. 8 is a schematic plan diagram for describing the shift amounts of a dither matrix in the region TE (p, q).

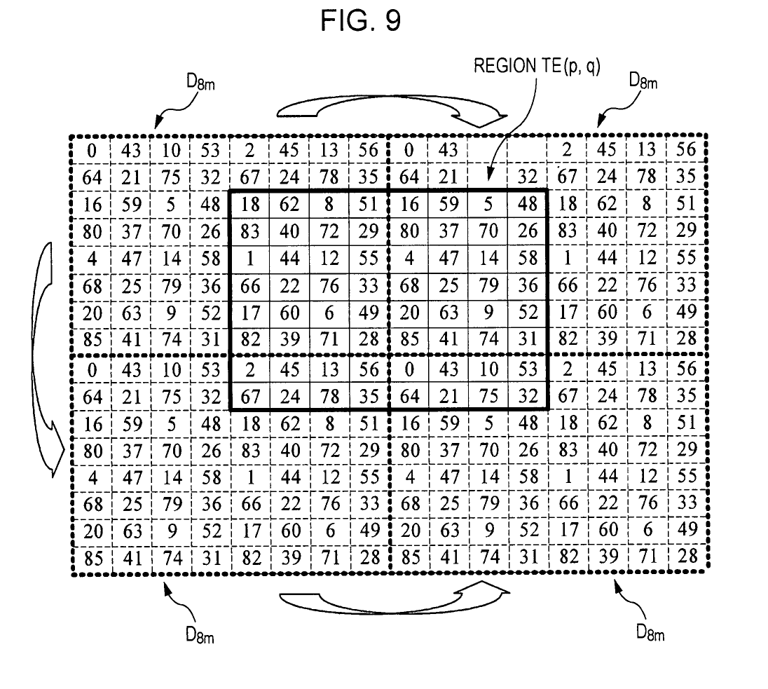

As illustrated in FIG. 8, in the First Embodiment, a dither matrix is applied by being shifted in the horizontal direction by ΔI (p, q) and in the vertical direction by ΔJ (p, q) in the region TE (p, q). Further, as illustrated in FIG. 9, the dither matrix D₈ₘ is applied by being hypothetically chained in the region TE (p, q). As will be described later with reference to FIG. 11, the values of ΔI (p, q) and ΔJ (p, q) are set randomly according to the combination of the symbols “p, q”.

As described above, the dither matrix D₈ₘ is composed of a Bayer type matrix. In the First Embodiment, the gradation conversion unit 120 applies a dither matrix D₈ₘ that is randomly shifted in the horizontal direction and the vertical direction by an even number of pixels.

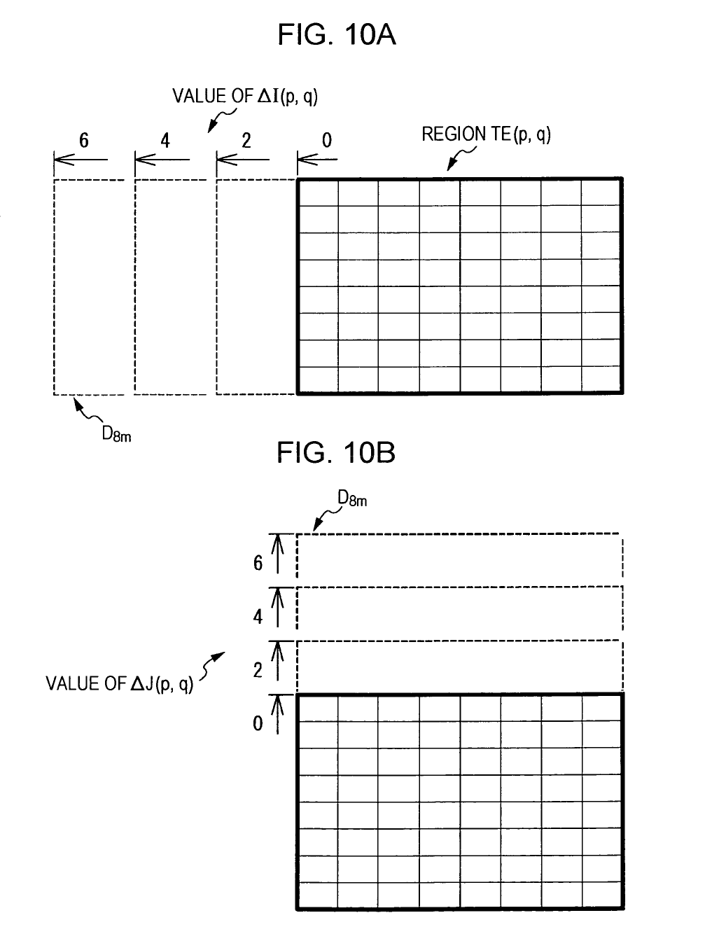

FIG. 10A is a schematic plan diagram for describing the shift amount of a dither matrix in the horizontal direction. FIG. 10B is a schematic plan diagram for describing the shift amount of a dither matrix in the vertical direction.

The dither matrix D₈ₘ is a square matrix of 8×8. Therefore, as illustrated in FIG. 10A, the shift amount ΔI (p, q) in the horizontal direction is any one of 0 pixels (shift amount 0), 2 pixels, 4 pixels, and 6 pixels. Similarly, as illustrated in FIG. 10B, the shift amount ΔJ (p, q) in a case when shifting in the vertical direction by an even number of pixels is any one of 0 pixels (shift amount 0), 2 pixels, 4 pixels, and 6 pixels.

FIG. 11 is a table in which the values of the shift amounts of a dither matrix in the horizontal direction and the vertical direction in the region TE (p, q) are shown.

The parameters illustrated in FIG. 11 are stored as a table in the shift amount generation unit 123 illustrated in FIG. 1. The table is created in advance and is stored in a non-volatile memory (not shown) or the like.

As illustrated in FIG. 11, the values of ΔI and ΔJ are set by randomly selecting one of “0, 2, 4, 6” according to the combination of the symbols “p, q”. Here, the table of FIG. 11 is merely one example of the selection.

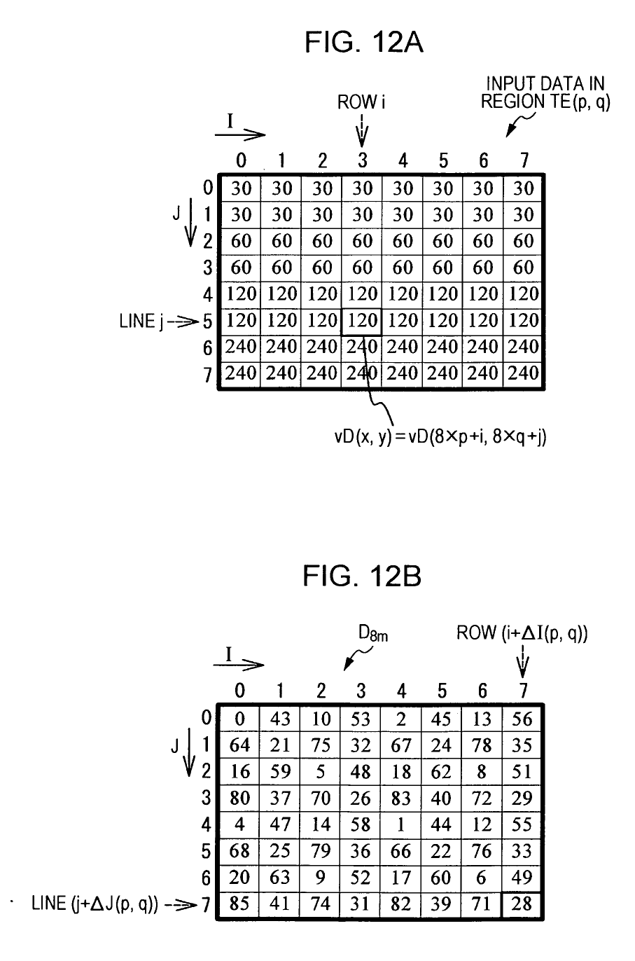

The action when shifting the dither matrix D₈ₘ will be described with reference to FIGS. 12A and 12B.

FIG. 12A is a schematic plan diagram for describing the value of input data that corresponds to a pixel that is positioned at column i, row j in the region TE (p, q). FIG. 12B is a schematic plan diagram for describing the value of a threshold that corresponds to a pixel that is positioned at column i, row j in the region TE (p, q) when a dither matrix is shifted.

The value of the input data in FIG. 12A is the same as in FIG. 7A. In the First Embodiment, the dither matrix D₈ₘ is applied by shifting the dither matrix D₈ₘ in the horizontal direction by ΔI (p, q) and in the vertical direction by ΔJ (p, q). The element of the dither matrix D₈ₘ at column (i+ΔI (p, q)) and row (j+ΔJ (p, q)) (that is, D₈ₘ (i+ΔI (p, q), j+ΔJ (p, q)) corresponds to the pixel 112 that is positioned at column i, row j in the region TE (p, q).

In the example illustrated in FIG. 11, in the region TE (p, q), ΔI (p, q)=4 and ΔJ (p, q)=2. Therefore, in a case when, for example, i=3 and j=5, the element of the dither matrix D₈ₘ at column (3+4) and row (5+2), that is, D₈ₘ (7, 7) corresponds to the value “120” illustrated in FIG. 12A.

The gradation conversion unit 120 performs a process of applying a dither matrix D₈ₘ that is shifted in the horizontal direction and the vertical direction to each region of the pixels 112 that corresponds to the dither matrix D₈ₘ, based on an image display program that is stored in a storage device (not shown).

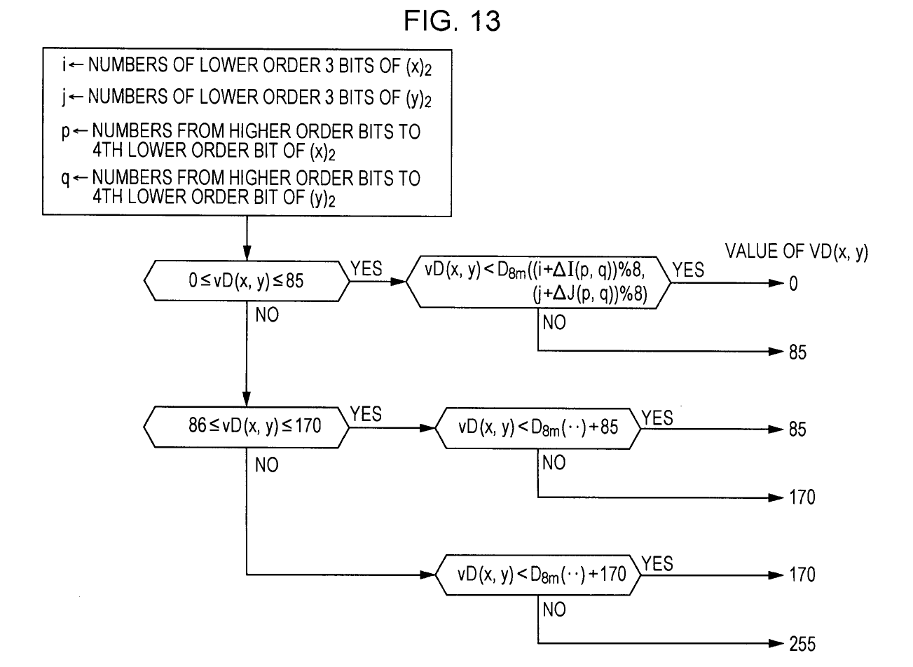

FIG. 13 is a schematic flowchart for describing the actions of the gradation conversion unit of the image display device according to the First Embodiment.

As described with reference to FIG. 6, the symbols “i, j” are respectively expressed by numbers from the 3 lower order bits of (x)₂ and (y)₂. Further, the symbols “p, q” are respectively expressed by numbers from the higher order bits to the 4th lower order bit of (x)₂ and (y)₂.

The gradation conversion unit 120 determines the values of the symbols “p, q, i, j” according to the values of the symbol x, y in the input data vD (x, y) and reads the values of the shift amounts ΔI (p, q) and ΔJ (p, q) from the table of the shift amount generation unit 123 in accordance with the combination of the symbols “p, q”.

Furthermore, in a case when the value of the input data vD (x, y) that corresponds to the pixel 112 (x, y) that is positioned at column x, row y in the display region 111 is equal to or greater than 0 and equal to or less than 85, if the input data vD (x, y)<D₈ₘ ((i+ΔI (p, q)) %8, (j+ΔJ (p, q)) %8), the dither processing unit 121 that configures the gradation conversion unit 120 makes the value of the output data VD (x, y) 0. The above “%” indicates a remainder operator. For example, (i+ΔI (p, q)) %8 indicates the remainder when (i+ΔI (p, q)) is divided by 8. In a case when the above conditions are not established, in other words, if the input data vD (x, y)≧D₈ₘ (i+ΔI (p, q), j+ΔJ (p, q)), the value of the output data VD (x, y) becomes 85.

Here, when a number in which (i+ΔI (p, q)) is represented in binary form is represented as (i+ΔI (p, q))₂ and a number in which (j+ΔJ (p, q)) is represented in binary form is represented as (j+ΔJ (p, q))₂, (i+ΔI (p, q)) %8=the lower order 3 bits of (i+ΔI (p, q))₂ and (j+ΔJ (p, q)) %8=the lower order 3 bits of (j+ΔJ (p, q))₂.

Further, in a case when the value of the input data vD (x, y) is equal to or greater than 86 and equal to or less than 170, if the input data vD (x, y)<[D₈ₘ ((i+ΔI (p, q)) %8, (j+ΔJ (p, q)) %8)+85], the value of the output data VD (x, y) becomes 85. In a case when the above conditions are not established, in other words, if the input data vD (x, y)≧[D₈ₘ ((i+ΔI (p, q)) %8, (j+ΔJ (p, q)) %8)+85], the value of the output data VD becomes 170.

Further, in a case when the value of the input data vD (x, y) is equal to or greater than 171 and equal to or less than 255, if the input data (x, y)<[D₈ₘ ((i+ΔI (p, q)) %8, (j+ΔJ (p, q)) %8)+170], the value of the output data VD becomes 170. In a case when the above conditions are not established, in other words, if the input data vD (x, y)≧[D₈ₘ ((i+ΔI (p, q)) %8, (j+ΔJ (p, q)) %8)+170], the value of the output data VD becomes 255.

By performing sequential determination of the input data vD (0, 0) to vD (X−1, Y−1) according to the flowchart illustrated in FIG. 13, the output data VD (0, 0) to VD (X−1, Y−1) is able to be obtained.

Here, although the input data vD is able to be input to the gradation conversion unit 120, for example, in order from vD (0,0) to vD (X−1, 0), . . . , vD (0, Y−1) to vD (X−1, Y−1) (so-called linear sequentially), the order of input is not limited thereto. As long as there is no impediment to the action of the image display device 1, the input data vD may be input to the gradation conversion unit 120 in any order. For example, a configuration in which the input data vD that corresponds to each region TE is input to the gradation conversion unit 120 to each region TE may be adopted.

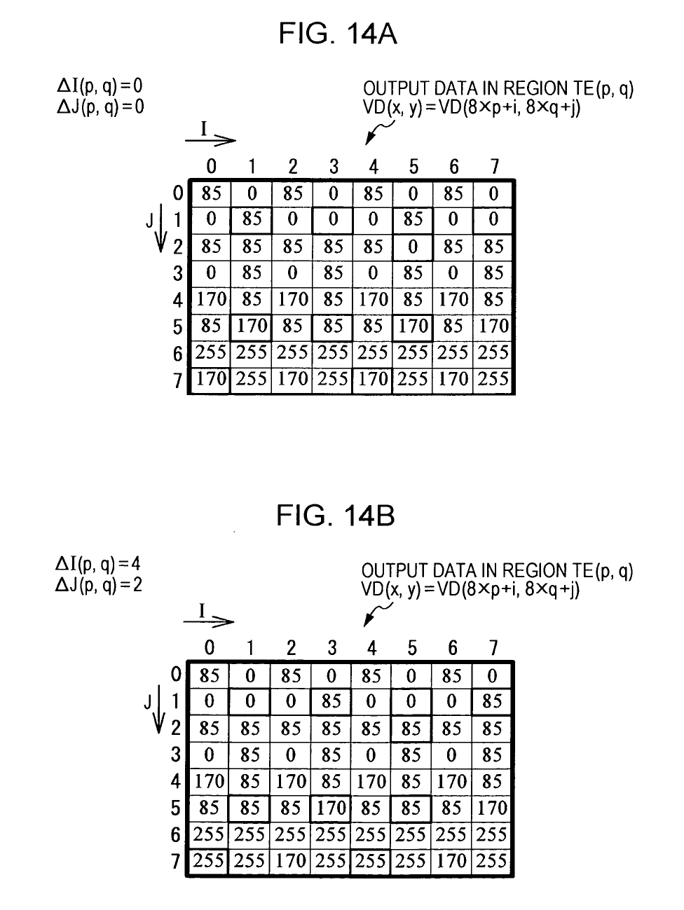

FIGS. 14A and 14B are tables for comparing output data from when dither processing of the driving method of the related art is performed and output data from when the dither processing of the driving method of the First Embodiment is performed on input data that corresponds to the pixels in the region TE (p, q). The result of the dither processing of the related art is illustrated in FIG. 14A, and the result of the dither processing of the First Embodiment is illustrated in FIG. 14B.

By applying a dither matrix D₈ₘ that is shifted, the values of the output data for several of the pixels 112 are changed in FIG. 14B with respect to FIG. 14A. Here, for identification, the relevant pieces of data are enclosed by bold lines.

Further, since the shift amounts of the dither matrix D₈ₘ in the region TE (0, 0) to TE (P−1, Q−1) are random, regular output patterns are not generated in accordance with the arrangement of the dither matrix D₈ₘ. Further, since a dither matrix D₈ₘ of a diffusion type is used, high resolution is compatible with high gradation characteristics, and grain-like pattern noise is able to be reduced.

In a case when gradation converting the input data vD of a moving image according to the flowchart of FIG. 13, the shift amounts ΔI (p, q) and ΔJ (p, q) of the dither matrix D₈ₘ are fixed regardless of differences in the display frames. That is, the gradation conversion unit 120 applies the dither matrix D₈ₘ that is shifted by the same amount in a region of the pixels 112 that corresponds to the dither matrix D₈ₘ for each display frame. Therefore, when an observer views the moving image, a problem in which noise is observed in the moving image due to the shifting of the dither matrix D₈ₘ does not arise.

Here, in the First Embodiment, although only one table is illustrated in FIG. 11, by preparing a plurality of tables, a configuration in which switching of tables according to the action mode of the image display device 1 is possible may be adopted. For example, a configuration of switching between a table that is suited to image observation at low brightness and a table that is suited to image observation at high brightness is possible.

### Second Embodiment

The Second Embodiment is a modification of the First Embodiment. In the Second Embodiment, a pixel is configured by a plurality of types of subpixels, and the gradation conversion unit applies a dither matrix for each type of subpixel that configures a region of pixels that corresponds to the dither matrix. The Second Embodiment differs from the First Embodiment on the following points.

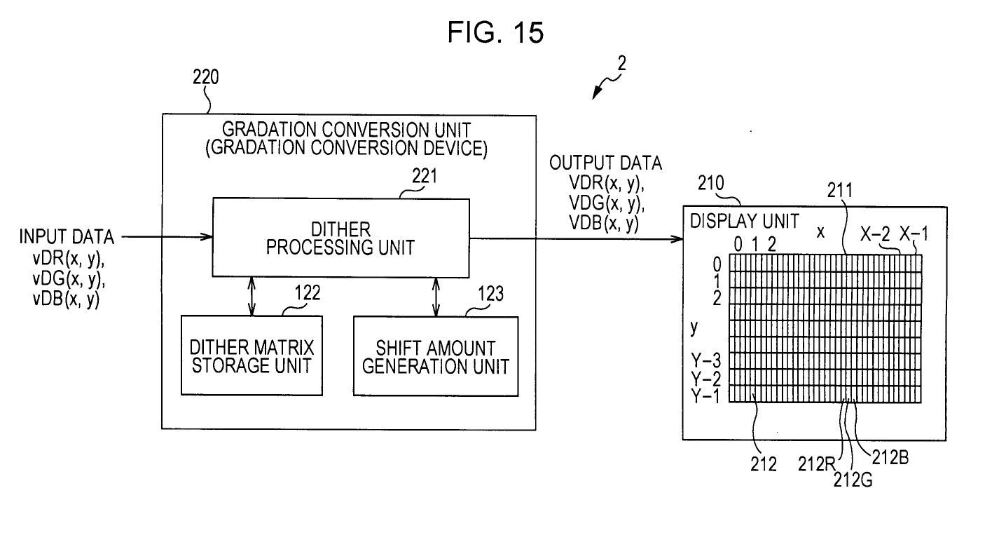

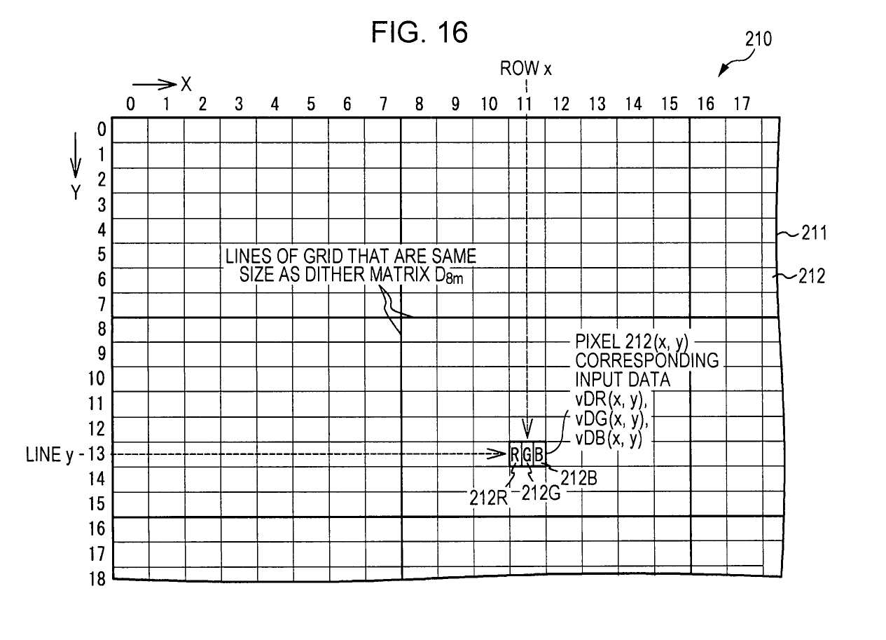

FIG. 15 is a conceptual diagram of an image display device according to a Second Embodiment. FIG. 16 is a schematic plan diagram for describing the relationship between a pixel that is positioned at column x, row y and input data in a display region, and a region of pixels that corresponds to a dither matrix.

An image display device 2 according to the Second Embodiment also includes a display unit 210 that displays an image by pixels 212 that are arranged in a two-dimensional matrix pattern and a gradation conversion unit 220 for performing gradation conversion using a diffusion type dither matrix D₈ₘ. Similarly to the First Embodiment, the gradation conversion unit 220 applies the dither matrix D₈ₘ that is randomly shifted in the horizontal direction and the vertical direction to each region of the pixels 212 that corresponds to the dither matrix D₈ₘ, and performs gradation conversion of the image of the display unit 210.

The display unit 210 is configured by a liquid crystal display panel of a color display. A total of X×Y pixels 212 are also arranged in a two-dimensional matrix pattern in a display region 211 of the display unit 210. The arrangement relationship of the pixels 212 in the display region 211 is the same as the arrangement relationship of the pixels 112 in the display region 111 described in the First Embodiment.

A pixel 212 is configured by a plurality of subpixels. Specifically, a pixel 212 includes a first subpixel 212R that displays red, a second subpixel 212G that displays green, and a third subpixel 212B that displays blue. In the case of a transmission type display panel, by the light transmissivity of the subpixels being controlled based on the values of the output data, the transmission amount of light from a light source device (not shown) is controlled and a color image is displayed on the display unit 210. In the case of a reflection type display panel, the light reflectivity of the subpixels are controlled based on the values of the output data and a color image is displayed on the display unit 210. The gradation conversion unit 220 applies the dither matrix D₈ₘ to each type of subpixel that configures a region of the pixels 212 that corresponds to the dither matrix D₈ₘ. Here, in order to improve the brightness or to expand the color reproduction range, for example, subpixels that display other colors may be further included.

The gradation conversion unit 220 includes a dither processing unit 221, the dither matrix storage unit 122, and the shift amount generation unit 123. The configurations of the dither matrix storage unit 122 and the shift amount generation unit 123 are the same as those described in the First Embodiment. The dither matrix D₈ₘ is composed of a Bayer matrix, and the gradation conversion unit 220 applies the dither matrix D₈ₘ that is randomly shifted in the horizontal direction and the vertical direction by an even number of pixels. In the Second Embodiment, the dither matrix D₈ₘ is applied by being shifted by the same conditions for the subpixels that configure a region of the pixels 212 that corresponds to the dither matrix D₈ₘ.

Input data vDR, vDG, and vDB that correspond to the first subpixel 212R, the second subpixel 212G, and the third subpixel 212B that configure a pixel 212 are input to the gradation conversion unit 220. By the dither processing unit 211, gradation conversion is performed based on the values of the dither matrix storage unit 122, the values of the shift amount generation unit 123, or the like, and the output data VDR, VDG, and VDB are output.

Similarly to the First Embodiment, a pixel 212 that is positioned at column x and row y is represented as the (x, y) pixel 212 or the pixel 212 (x, y). The same is also true of the first subpixel 212R, the second subpixel 212G, and the third subpixel 212B that configure the pixel 212 (x, y).

Further, the input data vDR and the output data VDR that correspond to the first subpixel 212R (x, y) are respectively expressed as the input data vDR (x, y) and the output data VDR (x, y). The same is also true of the input data vDG and the output data VDG that correspond to the second subpixel 212G (x, y) and the input data vDB and the output data VDB that correspond to the third subpixel 212B (x, y).

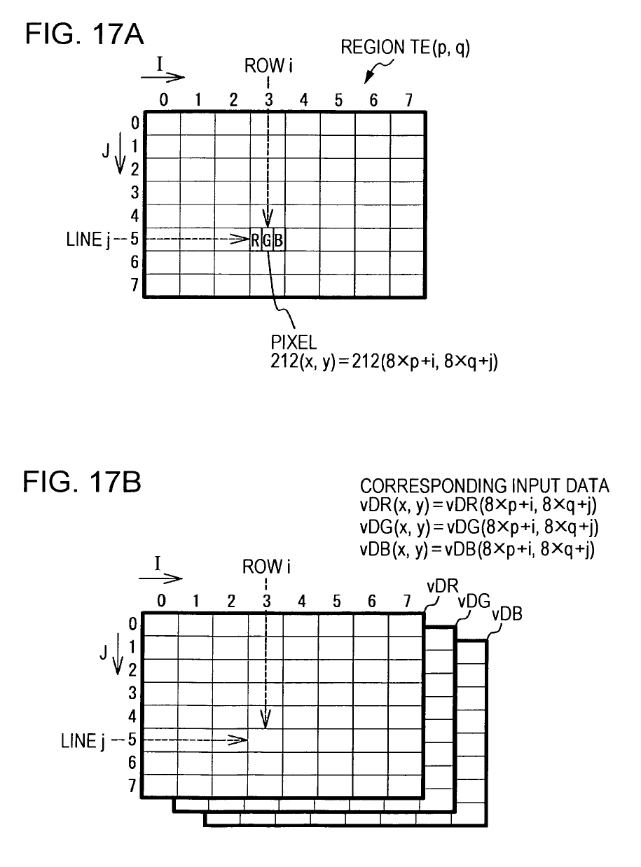

FIG. 17A is a schematic plan diagram for describing the relationship between the three subpixels that configure a pixel that is positioned at column x, row y in a display region and the three subpixels that configure a pixel that is positioned at column i, row j in the region TE (p, q). FIG. 17B is a schematic plan diagram for describing the relationship between the three subpixels that configure a pixel that is positioned at column i, row j in the region TE (p, q) and input data that corresponds to each subpixel.

Since the relationship between the symbols “x, y, p, q, i, j” is the same as that described in the First Embodiment, description thereof is omitted. As illustrated in FIG. 17B, vDR, vDB, and vDG correspond to the region TE (p, q) as input data. Therefore, the dither processing unit 221 illustrated in FIG. 15 respectively performs gradation processing for the input data vDR, vDB, and vDG.

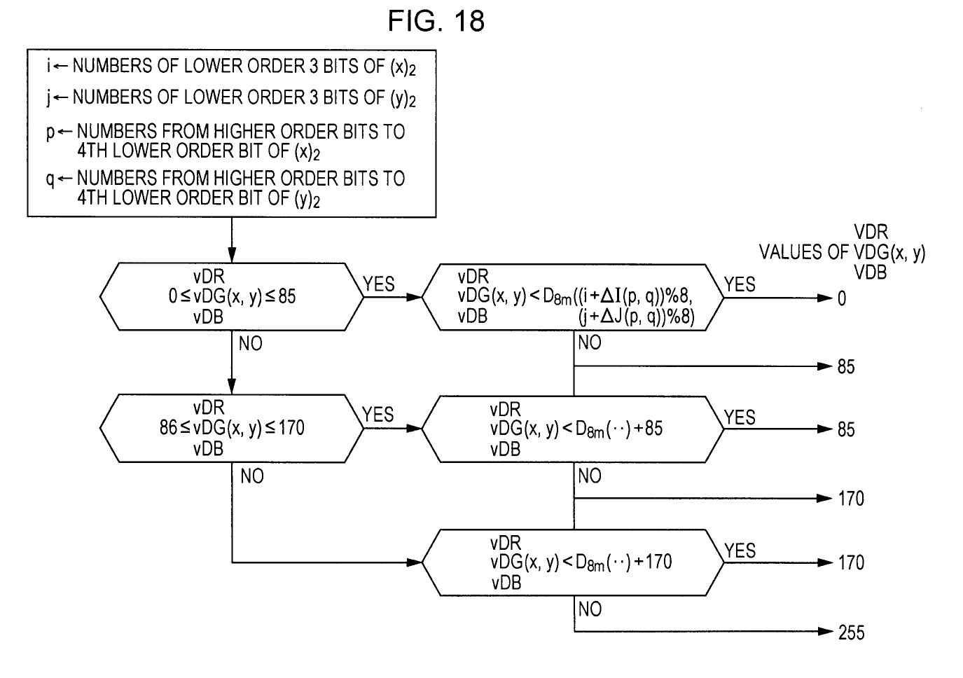

FIG. 18 is a schematic flowchart for describing the actions of the gradation conversion unit of the image display device according to the Second Embodiment.

In the Second Embodiment, the same processing as the processing of the input data vD in the First Embodiment is respectively performed for the input data vDR, vDB, and vDG. The values of the shift amounts ΔI (p, q) and ΔJ (p, q) are the same for the input data vDR, vDB, and vDG. Therefore, in the Second Embodiment, the dither matrix D₈ₘ that is shifted by the same conditions is applied to each of the subpixels.

Since details of the actions of the dither processing unit 221 that configures the gradation conversion unit 220 are able to be obtained by appropriately rereading the description of the actions of the dither processing unit 121 of the First Embodiment with reference to FIG. 13, description thereof is omitted.

### Third Embodiment

The Third Embodiment is a modification of the Second Embodiment. The main difference with the Second Embodiment is that in the Third Embodiment, dither matrices that are shifted by different conditions are applied to each of the subpixels.

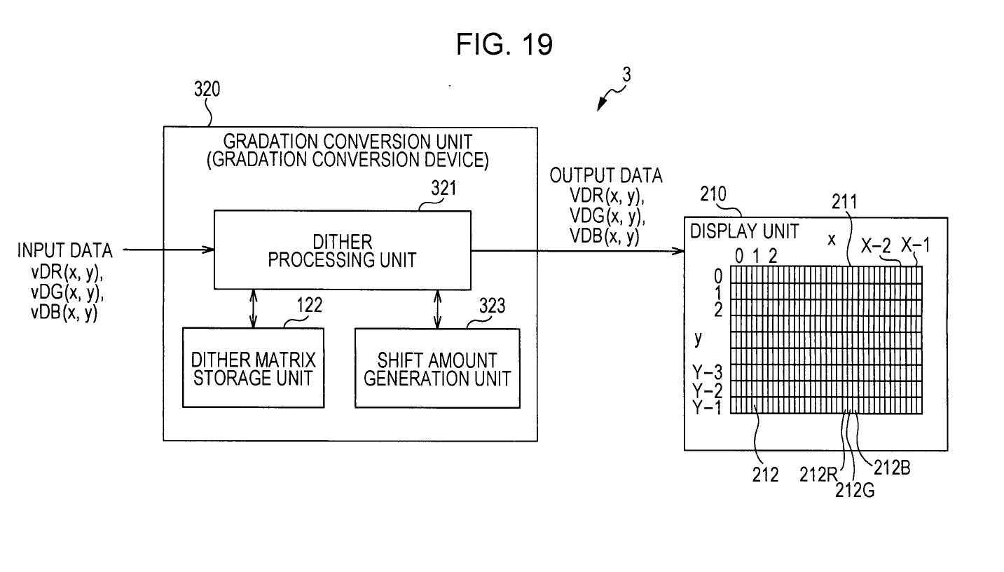

FIG. 19 is a conceptual diagram of an image display device according to the Third Embodiment.

An image display device 3 according to the Third Embodiment also includes the display unit 210 that displays an image by pixels 212 that are arranged in a two-dimensional matrix pattern and a gradation conversion unit 320 for performing gradation conversion using a diffusion type dither matrix. Similarly to the First Embodiment, the gradation conversion unit 320 applies a dither matrix that is randomly shifted in the horizontal direction and the vertical direction to each region of the pixels 212 that corresponds to the dither matrix, and performs gradation conversion of the image of the display unit 210.

Since the configuration of the display unit 210 is the same as that described in the Second Embodiment, description thereof is omitted.

The gradation conversion unit 320 includes a dither processing unit 321, the dither matrix storage unit 122, and a shift amount generation unit 323. The configuration of the dither matrix storage unit 122 is the same as that described in the First Embodiment. The dither matrix D₈ₘ is composed of a Bayer matrix, and the gradation conversion unit 320 applies the dither matrix D₈ₘ that is randomly shifted in the horizontal direction and the vertical direction by an even number of pixels.

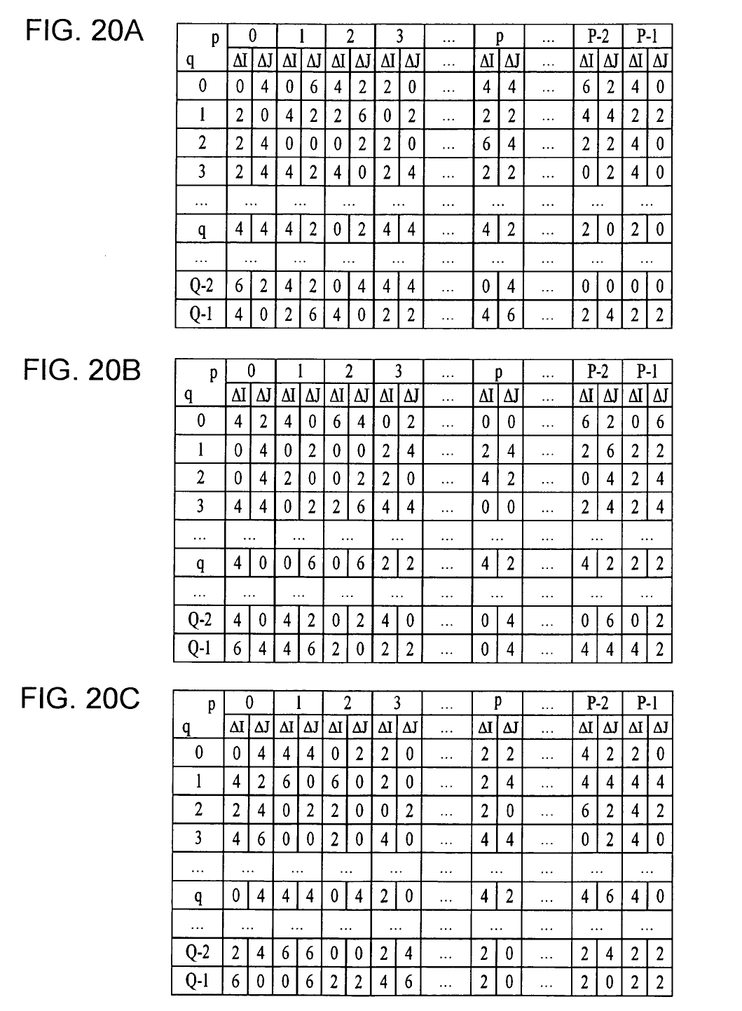

FIG. 20A is a table in which the values of the shift amounts of a dither matrix that corresponds to a first subpixel in the region TE (p, q) in the horizontal direction and the vertical direction are shown. FIG. 20B is a table in which the values of the shift amounts of a dither matrix that corresponds to a second subpixel in the region TE (p, q) in the horizontal direction and the vertical direction are shown. FIG. 20C is a table in which the values of the shift amounts of a dither matrix that corresponds to a third subpixel in the region TE (p, q) in the horizontal direction and the vertical direction are shown.

The three types of tables illustrated in FIGS. 20A to 20C are stored in the shift amount generation unit 323 illustrated in FIG. 19. Such tables are created in advance, and are stored in a non-volatile memory (not shown) or the like.

Similarly to the description in the First Embodiment with reference to FIG. 11, the values illustrated in FIGS. 20A to 20C are set by randomly selecting one of “0, 2, 4, 6” according to the combination of the symbols (p, q). Here, the selections in the tables of FIGS. 20A to 20C are merely examples.

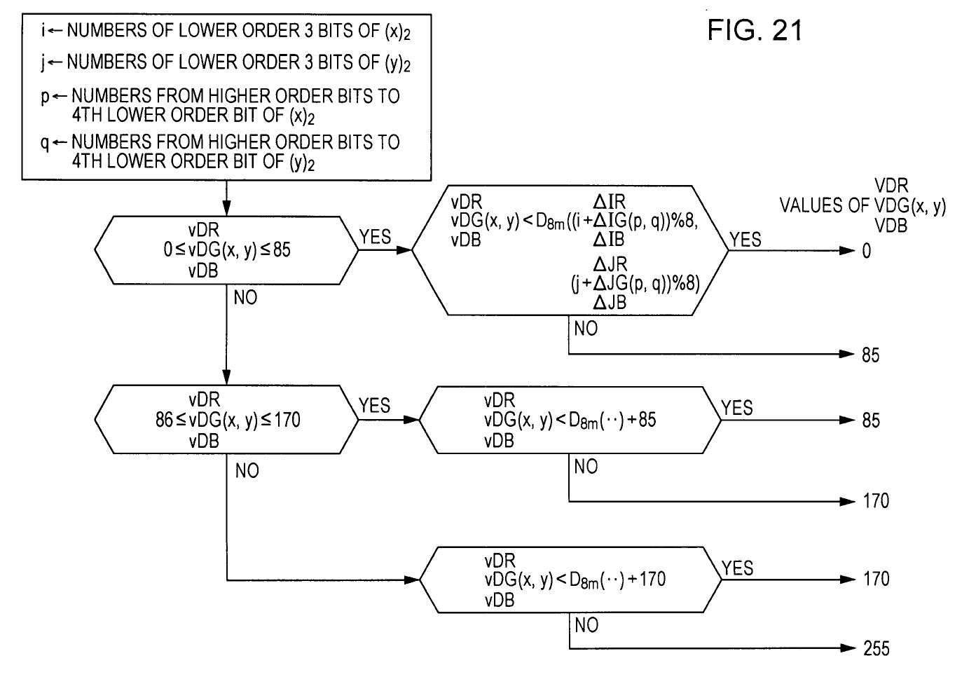

FIG. 21 is a schematic flowchart for describing the actions of a gradation conversion unit of the image display device according to the Third Embodiment.

In the Third Embodiment, basically, processing that is similar to the processing of the input data vD in the First Embodiment is also respectively performed for the input data vDR, vDB, and vDG. However, when processing the input data vDR (x, y) that corresponds to the pixel 212R (x, y), the dither processing unit 321 illustrated in FIG. 19 uses ΔIR (p, q) and ΔJR (p, q) as the shift amounts of the dither matrix D₈ₘ and determines the values of the output data VDR based on the actions illustrated in the flowchart.

Furthermore, when processing the input data vDG (x, y) that corresponds to the pixel 212G (x, y), ΔIG (p, q) and ΔJG (p, q) are used as the shift amounts of the dither matrix D₈ₘ and the values of the output data VDG are determined based on the actions illustrated in the flowchart.

Further, when processing the input data vDB (x, y) that corresponds to the pixel 212B (x, y), ΔIB (p, q) and ΔJB (p, q) are used as the shift amounts of the dither matrix D₈ₘ and the values of the output data VDB are determined based on the actions illustrated in the flowchart.

In the Third Embodiment, the shift amounts of the dither matrix D₈ₘ for each of the subpixels are able to be different in the gradation processing of the region TE (p, q). In so doing, a pattern that corresponds to the arrangement of the dither matrix D₈ₘ becomes less visible.

### Fourth Embodiment

The Fourth Embodiment is also a modification of the Second Embodiment. In the Fourth Embodiment, the gradation conversion unit applies a dither matrix that is shifted by the same conditions for at least two types of subpixels and applies a dither matrix that is shifted by different conditions for other types of subpixels in a region of the pixels 212 that corresponds to the dither matrix. Such points are the main differences from the Second Embodiment.

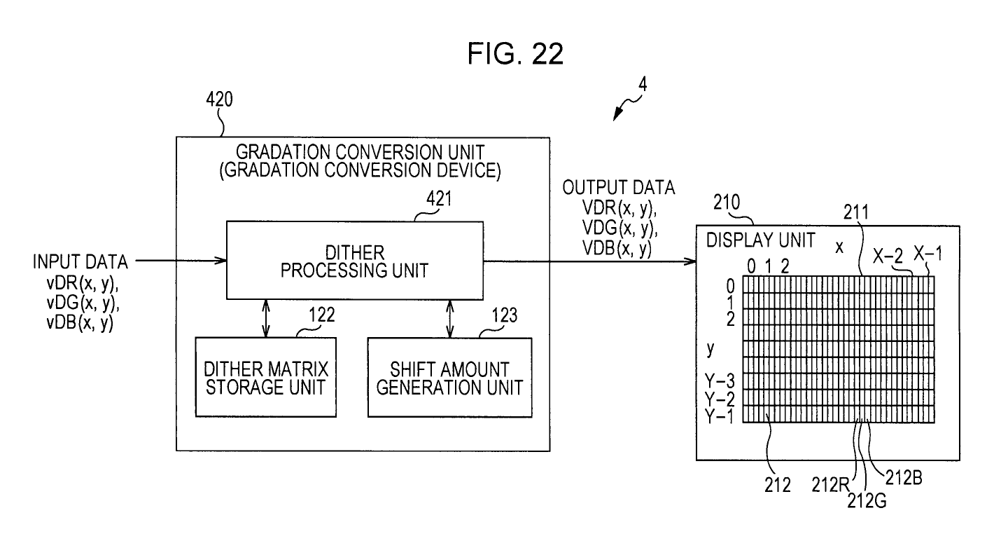

FIG. 22 is a conceptual diagram of an image display device according to the Fourth Embodiment.

An image display device 4 according to the Fourth Embodiment also includes the display unit 210 that displays an image by pixels 212 that are arranged in a two-dimensional matrix pattern and a gradation conversion unit 420 for performing gradation conversion using a diffusion type dither matrix D₈ₘ. Similarly to the First Embodiment, the gradation conversion unit 420 applies the dither matrix D₈ₘ that is randomly shifted in the horizontal direction and the vertical direction to each region of the pixels 212 that corresponds to the dither matrix D₈ₘ, and performs gradation conversion of the image of the display unit 210.

Since the configuration of the display unit 210 is the same as that described in the Second Embodiment, description thereof is omitted.

The gradation conversion unit 420 includes a dither processing unit 421, the dither matrix storage unit 122, and the shift amount generation unit 123. Since the configurations of the dither matrix storage unit 122 and the shift amount generation unit 123 are the same as those described in the First Embodiment, description thereof is omitted. The dither matrix D₈ₘ is composed of a Bayer matrix, and the gradation conversion unit 420 applies the dither matrix D₈ₘ that is randomly shifted in the horizontal direction and the vertical direction by an even number of pixels.

More specifically, the gradation conversion unit 420 applies the dither matrix D₈ₘ that is shifted by the same conditions for two types of subpixels (first subpixel 212R and third subpixel 212B) and applies the dither matrix D₈ₘ that is further respectively shifted in the horizontal direction and the vertical direction by fixed amounts by the same conditions for other types of subpixels (second subpixel 212G) in a region of the pixels 212 that corresponds to the dither matrix D₈ₘ. The other types of subpixels are subpixels of a color that contributes the most to brightness.

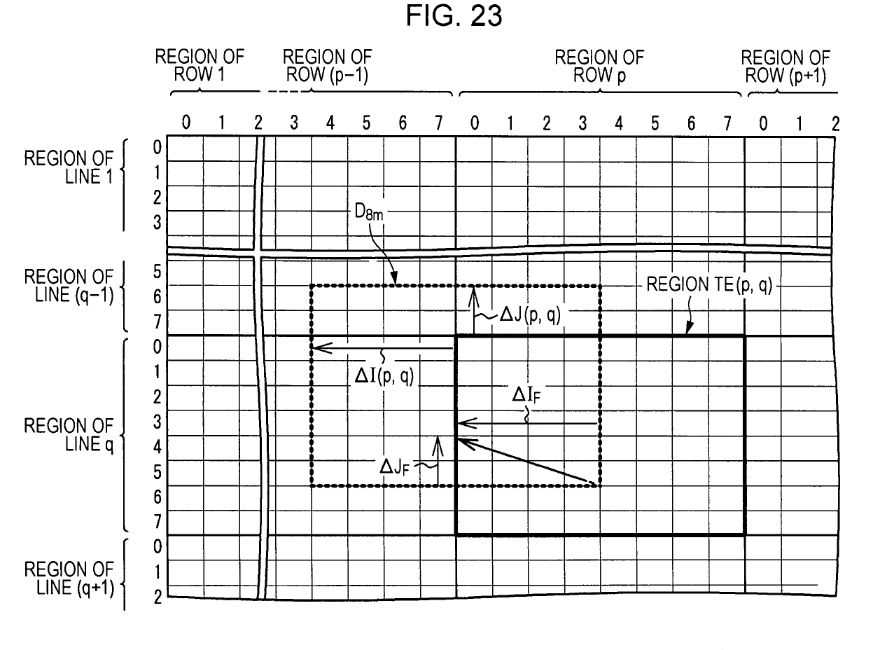

FIG. 23 is a schematic plan diagram for describing the shift amounts of a dither matrix that is applied to the first subpixel and the third subpixel in the region TE (p, q) and the shift amounts of a dither matrix that is applied to the second subpixel.

In the Fourth Embodiment, the same gradation conversion as that described in the First Embodiment is performed on the first subpixel 212R and the third subpixel 212B in the region TE (p, q). That is, processing is performed with the shift amounts of the dither matrix D₈ₘ on the first subpixel 212R and the third subpixel 212B as ΔI (p, q) and ΔJ (p, q). On the other hand, on the second subpixel 212G, processing is performed by further adding a fixed amount ΔI_{F} (ΔI_{F}=4 in the example illustrated in FIG. 23) to ΔI (p, q) and further adding a fixed amount ΔJ_{F} (ΔJ_{F}=2 in the example illustrated in FIG. 23) to ΔJ (p, q). Here, ΔI_{F} and ΔJ_{F} are fixed regardless of the values of the symbols “p, q”. Here, appropriate and preferable values according to the design of the image display device 4 or the like may be selected as the values of ΔI_{F} and ΔJ_{F}. In a case when the dither matrix is a Bayer type, it is preferable that the values of ΔI_{F} and ΔJ_{F} be basically values that correspond to an even number of pixels.

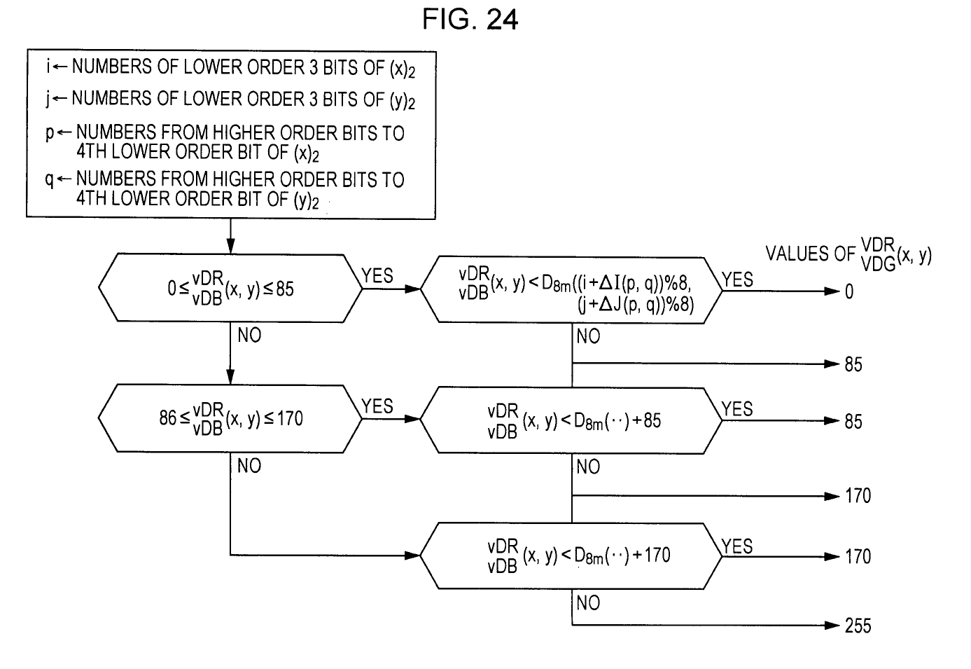

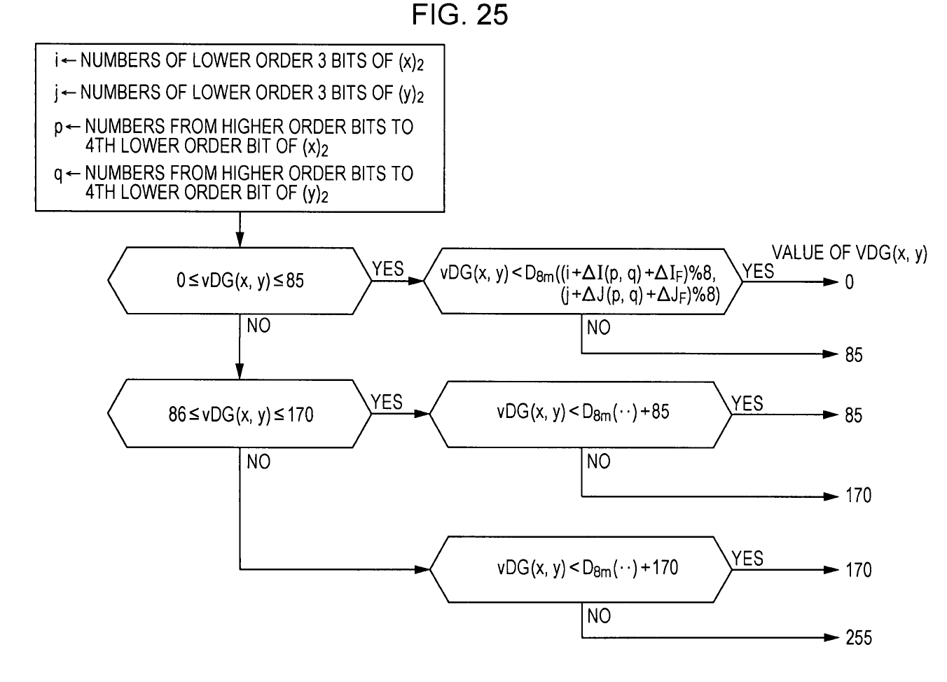

FIG. 24 is a schematic flowchart for describing the actions of the first subpixel and the third subpixel of the image display device according to the Fourth Embodiment. FIG. 25 is a schematic flowchart for describing the actions of the second subpixel of the image display device according to the Fourth Embodiment.

In the Fourth Embodiment, basically, a similar processing as the processing of the input data vD in the First Embodiment is also respectively performed for the input data vDR, vDB, and vDG. However, as illustrated in FIG. 24, when processing the input data vDR (x, y) that corresponds to the pixel 212R (x, y) and the input data vDB (x, y) that corresponds to the pixel 212B (x, y), the dither processing unit 421 uses ΔI (p, q) and ΔJ (p, q) as the shift amounts of the dither matrix D₈ₘ and determines the values of the output data VDR and VDB based on the actions illustrated in the flowchart.

Further, as illustrated in FIG. 25, when processing the input data vDG (x, y) that corresponds to the pixel 212G (x, y), the dither processing unit 421 uses [ΔI (p, q)+ΔI_{F}] and [ΔJ (p, q)+ΔJ_{F}] as the shift amounts of the dither matrix D₈ₘ and determines the values of the output data VDG based on the actions illustrated in the flowchart.

In the Fourth Embodiment, in the gradation processing of the region TE (p, q), as opposed to the first subpixel 212R and the third subpixel 212B, a dither matrix D₈ₘ that is further shifted by ΔI_{F} and ΔJ_{F} is applied to the second subpixel 212G of a color that contributes the most to brightness. In so doing, a pattern that corresponds to the arrangement of the dither matrix D₈ₘ becomes less visible.

According to the Fourth Embodiment, unlike in the Third Embodiment, there is no cause for a plurality of tables to be stored in a shift amount generation unit. Further, it is sufficient for the dither processing unit 421 to perform a determination that reflects ΔI_{F} and ΔJ_{F}. The configuration of the Fourth Embodiment also has the advantage of not causing an increase in the scale of the circuits.

### Fifth Embodiment

The Fifth Embodiment is also a modification of the Second Embodiment. In the Fifth Embodiment, the gradation conversion unit selects either one of a matrix in which a dither matrix is rotated and a matrix in which a dither matrix is inverted in the horizontal direction, the vertical direction, or a diagonal direction and applies the selected matrix as a dither matrix in each region of the pixels 212 that corresponds to the dither matrix. Such points are the main differences from the Second Embodiment.

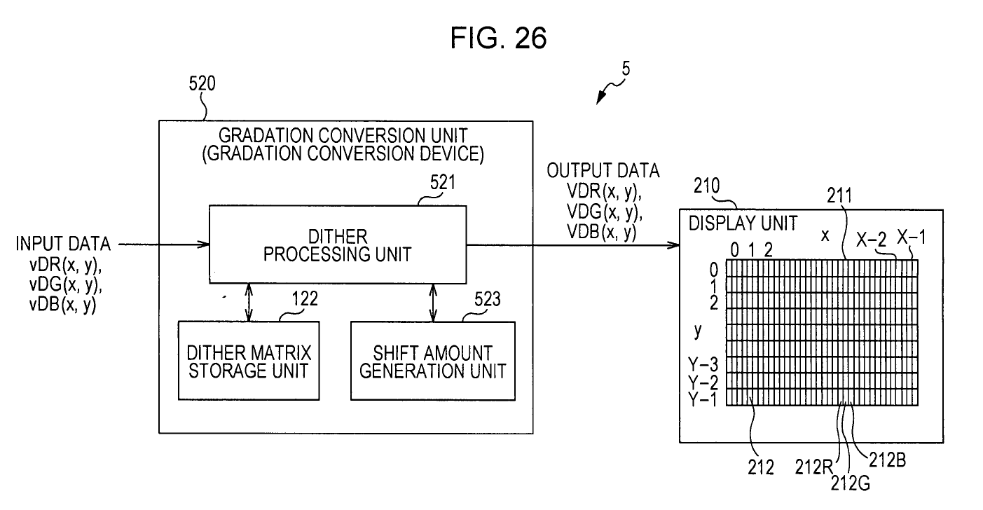

FIG. 26 is a conceptual diagram of an image display device according to the Fifth Embodiment.

An image display device 5 according to the Fifth Embodiment also includes the display unit 210 that displays an image by pixels 212 that are arranged in a two-dimensional matrix pattern and a gradation conversion unit 520 for performing gradation conversion using a diffusion type dither matrix. Similarly to the First Embodiment, the gradation conversion unit 520 applies the dither matrix that is randomly shifted in the horizontal direction and the vertical direction to each region of the pixels 212 that corresponds to the dither matrix, and performs gradation conversion of the image of the display unit 210.

Since the configuration of the display unit 210 is the same as the display unit 210 that is described in the Second Embodiment, description thereof is omitted.

The gradation conversion unit 520 includes a dither processing unit 521, the dither matrix storage unit 122, and the shift amount generation unit 523. The configuration of the dither matrix storage unit 122 is the same as that described in the first Embodiment. The dither matrix D₈ₘ is composed of a Bayer matrix, and the gradation conversion unit 520 applies a dither matrix D₈ₘ that is randomly shifted in the horizontal direction and the vertical direction by an even number of pixels.

The shift amount generation unit 523 further includes a table in which dither matrix deformation parameters to each region TE (p, q) is stored in addition to the table illustrated in FIG. 11 reference in the First Embodiment.

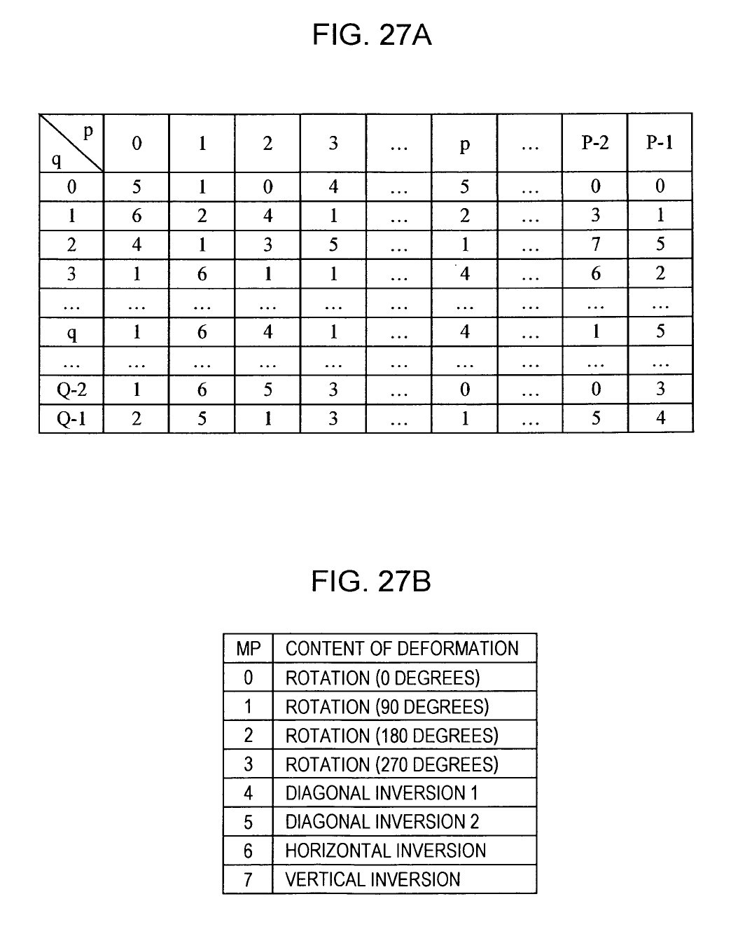

FIG. 27A is a table in which the values of matrix deformation parameters in the region TE (p, q) are shown.

A matrix deformation parameter MP is an integer of a value “between 0 and 7”. In the table of FIG. 27A, one of the values “between 0 and 7” is randomly selected and set according to the combination of the symbols “p, q”. Such a table is created in advance and stored in a non-volatile memory (not shown) or the like. In the Fifth Embodiment, there are eight deformation patterns of the dither matrix D₈ₘ.

FIG. 27B is a table in which the correspondence relationship between matrix deformation parameters and the content of the deformation is shown.

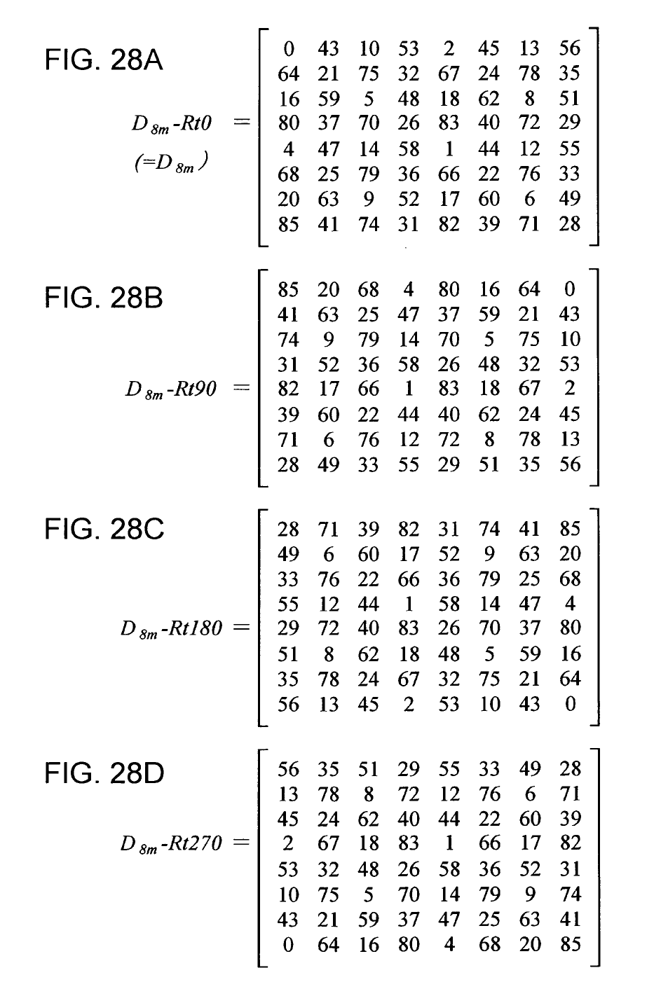

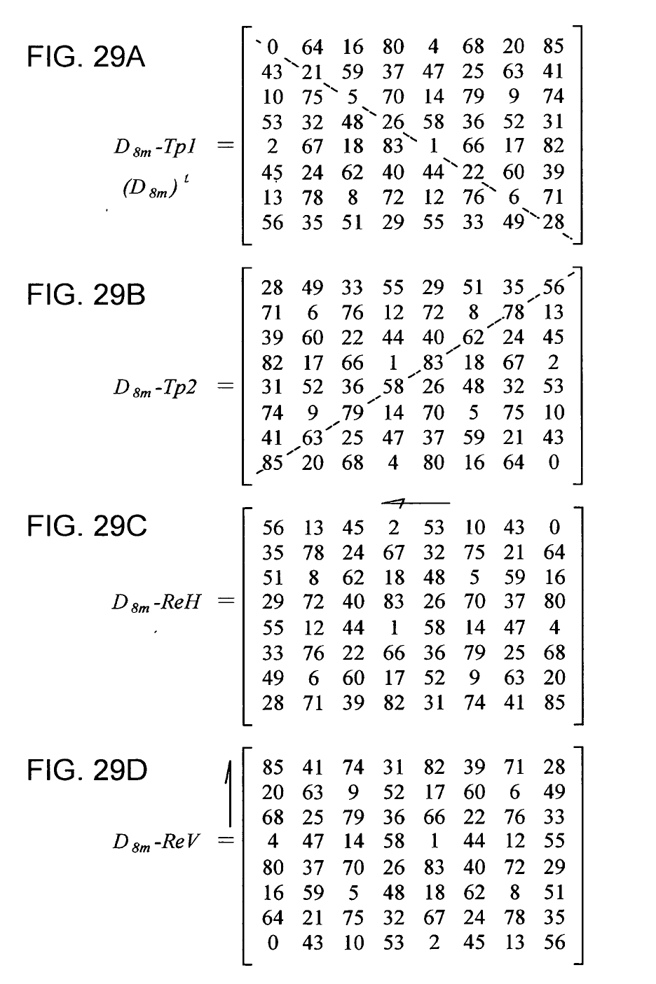

FIGS. 28A to 28D are diagrams on which a dither matrix is shown when the matrix conversion parameter is respectively 0 to 3. FIGS. 29A to 29D are diagrams on which a dither matrix is shown when the matrix conversion parameter is respectively 4 to 7.

In a case when the MP is between 0 and 3, matrices in which each element of the dither matrix D₈ₘ is rotated by 0 degrees, 90 degrees, 180 degrees, and 270 degrees respectively correspond to the MP. FIGS. 28A to 28D illustrate the respective matrices.

Furthermore, in a case when the MP is between 4 and 7, matrices in which the dither matrix D₈ₘ is inverted in the horizontal direction, the vertical direction, or a diagonal direction respectively correspond to the MP. Specifically, in a case when the MP is 4, a matrix that is inverted in a diagonal direction with one diagonal row as the axis corresponds to the MP (in other words, transposed matrix (D₈ₘ)^{t}) (refer to FIG. 29A). In a case when the MP is 5, a matrix that is inverted in a diagonal direction with the other diagonal row as the axis corresponds to the MP (refer to FIG. 29B). In a case when the MP is 6, a matrix that is inverted in the horizontal direction corresponds to the MP (refer to FIG. 29C). In a case when the MP is 7, a matrix that is inverted in the vertical direction corresponds to the MP (refer to FIG. 29D).

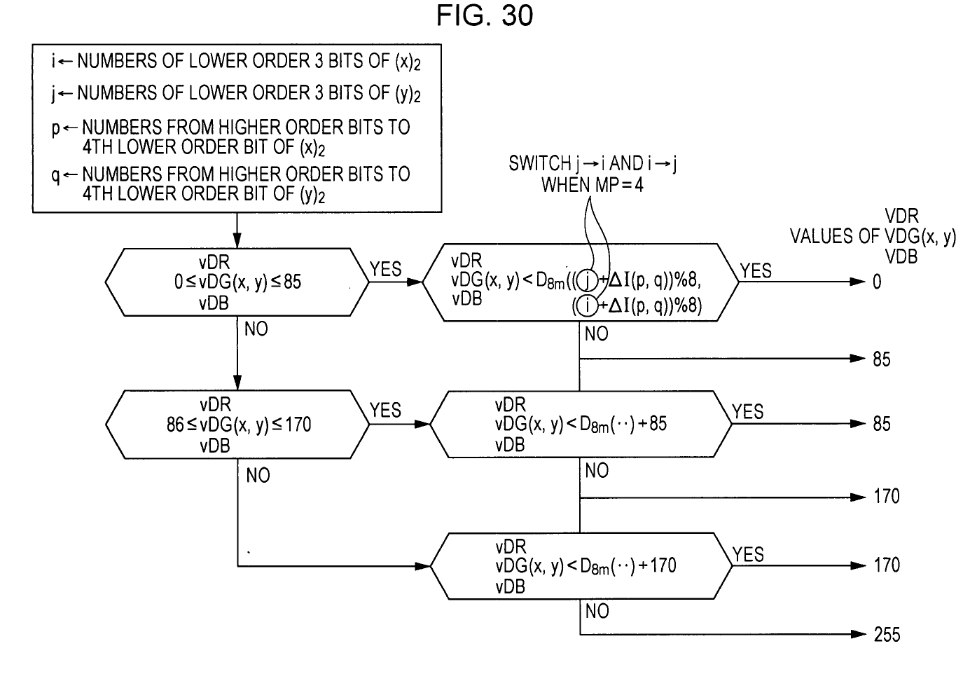

FIG. 30 is a schematic flowchart for describing the actions of a gradation conversion unit of an image display device according to the Fifth Embodiment.

In the Fifth Embodiment, basically, a similar processing as the processing of the input data vD in the First Embodiment is also respectively performed for the input data vDR, vDB, and vDG.

However, the dither processing unit 521 illustrated in FIG. 26 further reads the values of the matrix deformation parameters MP that correspond to the region TE (p, q) in addition to the shift amounts ΔI (p, q) and ΔJ (p, q) that correspond to the region TE (p, q) from the shift amount generation unit 523. Furthermore, the operation when reading the elements of the dither matrix D₈ₘ are appropriately changed according to the values of the matrix deformation parameters MP.

For example, in the example illustrated in FIG. 27A, when the symbols are “p, q”, the MP is 4. In such a case, as illustrated in FIG. 29A, a matrix in which the dither matrix D₈ₘ is transposed may be applied as the dither matrix. In reality, as illustrated in the flowchart of FIG. 30, a conditional judgment may be made by switching the symbol “i” with the symbol “j”. Here, in a case when the MP is not 4, a conditional judgment may be made by performing an operation such as switching the positive and the negative of the symbol “i” and “j” or adding a constant.

Here, in the case of the Fifth Embodiment, depending on the form of the deformation of the dither matrix D₈, it is conceivable that the phase of the high-frequency component shifts by one pixel. In such a case, a portion of the parameters illustrated in FIG. 11 may be changed to odd values.

Although the embodiments of the disclosure have been specifically described above, the disclosure is not limited to the embodiments described above, and various modifications based on the technical ideas of the disclosure are possible.

For example, although the shift amounts of the dither matrix are stored in a table in advance in the embodiments, for example, a configuration in which a linear feedback shift register (LFSR) is equipped as hardware or software and shift amounts are generated by causing random numbers of M series to be generated by the LFSR is also possible.

The present disclosure contains subject matter related to that disclosed in Japanese Priority Patent Application JP 2010-264760 filed in the Japan Patent Office on Nov. 29, 2010, the entire contents of which are hereby incorporated by reference.

What is claimed is:

1. An image display device comprising:
a display unit that displays an image by pixels that are arranged in a two-dimensional matrix pattern; and
a gradation conversion unit that performs gradation conversion using a dither matrix of diffusion type,
wherein the gradation conversion unit applies a dither matrix that is randomly shifted in a horizontal direction and a vertical direction and performs gradation conversion of an image that is displayed on a display unit to each region of pixels that corresponds to the dither matrix.

2. The image display device according to claim 1,
wherein the dither matrix is composed of a Bayer type matrix and
the gradation conversion unit applies the dither matrix that is randomly shifted in the horizontal direction and the vertical direction by every even numbered portion of the pixels.

3. The image display device according to claim 1,
wherein a pixel is configured by a plurality of types of subpixels, and
the gradation conversion unit applies the dither matrix for each type of the subpixels that configures the region of pixels that corresponds to the dither matrix.

4. The image display device according to claim 3,
wherein the pixel includes at least three types of subpixels, and
the gradation conversion unit applies the dither matrix shifted in a first condition to at least two types of subpixels in the region of pixels that corresponds to the dither matrix, and applies the dither matrix that is shifted in a second condition different from the first condition to the other type of subpixels.

5. The image display device according to claim 4,
wherein the gradation conversion unit applies the dither matrix shifted in the first condition to the two types of subpixels in the region of pixels that corresponds to the dither matrix, and further shifts and applies the dither matrix that is shifted by the first condition and modified by shifting in each of the horizontal direction and the vertical direction respectively by a fixed amount to the other type of subpixels.

6. The image display device according to claim 4,
wherein the other type of subpixels are subpixels of a color that contributes the most to brightness.

7. The image display device according to claim 1,
wherein the gradation conversion unit applies, for each display frame, a dither matrix that is shifted by the same amount in a region of pixels that corresponds to a dither matrix.

8. The image display device according to claim 1,
wherein the gradation conversion unit selects one of a matrix in which the dither matrix is rotated or a matrix in which the dither matrix is inverted in the horizontal direction, the vertical direction, or a diagonal direction and applies the selected matrix as the dither matrix to each region of pixels that corresponds to the dither matrix.

9. A driving method of an image display device using an image display device including a display unit that displays an image by pixels that are arranged in a two-dimensional matrix pattern and a gradation conversion unit that performs gradation conversion using a diffusion type dither matrix, comprising:
applying a dither matrix that is randomly shifted in a horizontal direction and a vertical direction to each region of pixels that corresponds to a dither matrix by the gradation conversion unit; and
performing gradation conversion of an image that is displayed on a display unit.

10. An image display program that causes a process to be executed in an image display device including a display unit that displays an image by pixels that are arranged in a two-dimensional matrix pattern and a gradation conversion unit that performs a gradation conversion using a diffusion type dither matrix, comprising:
applying a dither matrix that is randomly shifted in a horizontal direction and a vertical direction to each region of pixels that corresponds to a dither matrix by the gradation conversion unit; and
performing gradation conversion of an image that is displayed on a display unit.

11. A gradation conversion device comprising:
a gradation conversion unit that performs gradation conversion using a dither matrix of diffusion type,
wherein the gradation conversion unit applies the dither matrix that is randomly shifted in a horizontal direction and a vertical direction and performs gradation conversion of an image to each region of pixels that corresponds to the dither matrix.
